(19) United States
(12) Patent Application Publication
(10) Pub. No.: US 2013/0339180 A1
(43) Pub. Date: Dec. 19, 2013

(54) COLLECTION CREATOR AND ORGANIZER FOR SOCIAL MEDIA

(71) Applicants: Ronald Aaron LaPierre, LaVerne, CA (US); Paul Silvio Mineiro, Bellevue, WA (US); Talmadge Orion O'Neill, Altadena, CA (US); Thomas Andrew Soulanille, Pasadena, CA (US); Christopher Starace, La Canada, CA (US); Harry Tsao, Arcadia, CA (US)

(72) Inventors: Ronald Aaron LaPierre, LaVerne, CA (US); Paul Silvio Mineiro, Bellevue, WA (US); Talmadge Orion O'Neill, Altadena, CA (US); Thomas Andrew Soulanille, Pasadena, CA (US); Christopher Starace, La Canada, CA (US); Harry Tsao, Arcadia, CA (US)

(21) Appl. No.: 13/837,775

(22) Filed: Mar. 15, 2013

Related U.S. Application Data
(60) Provisional application No. 61/650,298, filed on May 22, 2012.
(60) Provisional application No. 61/612,021, filed on Mar. 16, 2012.

(51) Int. Cl. G06Q 50/00; G06Q 30/06

(52) U.S. Cl. CPC G06Q 50/01; G06Q 30/0631
USPC 705/26.7

(57) ABSTRACT

A multimedia content sharing system permits users to collect multimedia items into collections, collaborate on collections with other users and share items with others in collections. The multimedia content sharing system provides recommendations of other items and collections that a user may wish to follow. The multimedia content sharing system provides easy editing of a user's collections by a drag and drop interface.

### RELATED APPLICATIONS

The present patent document claims the benefit of the filing date under 35 U.S.C. §119(e) of Provisional U.S. Patent Application Ser. No. 61/650,298, filed May 22, 2012 and Provisional U.S. Patent Application Ser. No. 61/612,021, filed Mar. 15, 2012, which are hereby incorporated by reference in their entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

The present invention relates generally to online social media systems. More particularly, the present invention relates to collection enhancement for such social media systems.

One popular aspect provided through internet access is social media, or web sites which enable communication among two or more people having common interests. Examples of social media sites include those available at facebook.com, pinterest.com and twitter.com. Generally, such social media sites allow users to define a community having a common interest and to join such communities. Community members then share with each other, using online facilities provided by the web site, media they have encountered and wish to share. Community members can respond by commenting and rating the shared media or by sharing additional media with the community.

The media to be shared can be in a wide variety of formats. Generally, though, the shared media must be reducible to an electronic format for storage and conveyance to other community members. Thus, suitably encoded text, photos and video are prime sources of content to be shared, and the sharing is in the nature of stored and transmitted data files.

Current social media arrangements have been very successful. However, there are opportunities for increasing growth of acceptance of such social media arrangements and for enhancing the user's experience.

### BRIEF DESCRIPTION OF THE SEVERAL VIEWS OF THE DRAWINGS

FIG. 1 shows an example of an operating environment for implementing a multimedia content sharing system

FIG. 2 is a flow diagram illustrating an exemplary process for providing suggested images to a user by the multimedia content sharing system of FIG. 1.

FIG. 3 is a flow diagram illustrating an exemplary process for constructing a classifier in the multimedia content sharing system of FIG. 1.

FIG. 4 including FIG. 4A and FIG. 4B is a flow diagram illustrating an exemplary process for a presentation set function in the multimedia content sharing system of FIG. 1.

FIG. 5 is a flow diagram illustrating an exemplary process for finding a candidate set in the multimedia content sharing system of FIG. 1.

FIG. 6 is a flow diagram illustrating an exemplary process for constructing a training set in the multimedia content sharing system of FIG. 1.

FIG. 7 is a flow diagram illustrating an exemplary process for training a classifier in the multimedia content sharing system of FIG. 1.

FIG. 8 including FIG. 8A and FIG. 8B is a flow diagram illustrating an exemplary process for a collection item compatibility function in the multimedia content sharing system of FIG. 1.

FIG. 9 is a flow diagram illustrating an exemplary process for entering an item into a collection in the multimedia content sharing system of FIG. 1.

FIG. 10 including FIG. 10A, 10B and FIG. 10C is a flow diagram illustrating an exemplary process for determining a list of search queries in the multimedia content sharing system of FIG. 1.

FIG. 11 is an example profile-visitor view that may be displayed to a user of the multimedia content sharing system of FIG. 1.

FIG. 12 is an example profile-follower view that may be displayed to a user of the multimedia content sharing system of FIG. 1.

FIG. 13 is an example profile collection-follower view that may be displayed to a user of the multimedia content sharing system of FIG. 1.

FIG. 14 is an example profile-owner view that may be displayed to a user of the multimedia content sharing system of FIG. 1.

FIG. 15 is an example profile-owner view with collection organization activated, that may be displayed to a user of the multimedia content sharing system of FIG. 1.

FIG. 16 is an example profile-owner view with collections expanded for organization that may be displayed to a user of the multimedia content sharing system of FIG. 1.

FIG. 17 is an example showing dragging and dropping of collections in a web browser that may be displayed to a user and performed by the user of the multimedia content sharing system of FIG. 1.

FIG. 18 is an example showing dragging and dropping of images in a web browser that may be displayed to a user and performed by the user of the multimedia content sharing system of FIG. 1.

FIG. 19 is an image detail view.

FIG. 20 is a collection detail view of a user's collection.

FIG. 21 is a front stream view of a user's collections.

FIG. 22 is an image detail view for a user.

### DETAILED DESCRIPTION OF THE DRAWINGS AND THE PRESENTLY PREFERRED EMBODIMENTS

The operator of the social media site makes available suitable facilities for community use, such as memory for data storage, databases for data collection and classification and search, and user interface applications to simplify and unify the users' experience with the social media web site. The operator also provides account management for members and provides advertising which may be targeted to interests of individual members or communities.

All social media thrive and develop best when communities are growing and members are engaged and active. However, experience has shown that some members will lose interest in a relatively short amount of time. This can slow or stop the growth of online communities and limit the commercial success of the social media web site.

One current social media web site allows community members to identify images they locate on the World Wide Web. The identified images and links are aggregated for the user at the user's personal page of the social media web site. Other users can link their accounts so that they follow updates to the images located by the user. Other linked users or community members can view and rate and comment on the images and even add identified images to the personal page of the linked user or community member. Social media web sites of this sort have become popular among many of their members.

However, one area in which this sort of social media web site has been limited is in the area of facilitating and encouraging users to create groups of images, particularly ones with multiple images aggregated together. When a user identifies an image and adds it to her personal page, she is not provided by the social media web site with assistance or suggestions or additional content that the user might add to that personal page. She is left to continue searching on her own for images to share.

As a result, many personal pages are observed to contain only one or a small number of images. This tends to slow or stop the growth of the user's involvement with the social media web site, which reduces the value of her personal page, her degree of engagement and her sense of accomplishment. This also tends to slow or stop the growth of the communities of which she is a member and reduces the degree of engagement by other community members. From the perspective of the operator of the social media web site, this reduces the amount of information about the user that may be obtained and the ability to thereby attract other users and advertisers. This reduces the growth of the social media web site itself.

In one aspect the present disclosure provides method and apparatus allowing a user to define a collection of objects such as images and to extend the collection, both at the time the user adds the object to the collection and at other times as well.

The features disclosed herein are implemented in a computer based system accessible over one or more networks such as the internet. The system includes hardware and software which cooperate to provide the described features. Users may interact with the system over the one or more networks to view content of the system, add content, interact with other users and perform other functions. Advertisers may interact with the system to provide paid content, advertisements and other information for users. The system manages the content and requests of users, advertisers and other commercial entities. For example, the system may cooperate with a user to set up an account and to provide to the user information based on account settings. Also, the system may detect user actions, store those actions and perform in response to the actions or based on analysis of the actions. For example, the system may monitor user interactions to determine user preferences. Subsequently, the system may provide content, advertisements and other information to the user based on the determined user preferences. The system may perform other functions as well or in the alternative.

Collection Creator

Known social media sites could be improved by better facilitating and encouraging users to create collections, particularly ones with multiple pins. In the prior art, when a user pins or repins an image to a collection, the user is not provided with assistance or suggestions of additional content that the user might add to that collection. Consequently many collections are observed to contain only one or a small number of images. This reduces the value of the collection, the degree of user engagement, the user's sense of accomplishment, and the information about the user obtained.

In the present disclosure, when a user pins an image, the user can pin it to an existing or a new collection, as in the prior art. The present disclosure innovates by providing system and method for the user to extend a collection, at the time the user pins an image, and at other times as well.

Those the system and method make available to the user at the time of pinning include a User Interface (UI) for the user to select a plurality of images to pin, and to direct those various images each to one or more of a plurality of collections.

Further system and method are made available to the user upon the completion of primary pinning, that is, pinning from a source outside of the operator's site. In one embodiment, the user is presented with UI features to view the instant state of a collection. The UI proffers images that are not currently part of that collection and which the user may readily select to include in the collection.

The system may produce those proffered images by one or more techniques. In one embodiment, the system employs techniques from the area of art of machine learning to analyze the title the user has given to the collection, and, for each pin presently included in the collection, features of that pin.

The exemplary embodiments shown and described herein are generally presented in the context of images which may be accessed and shared by users. An image is a set of data that are instructions to a computer system for the construction of a two-dimensional array of luminance values in one or more wavelengths, or color channels, typically red, green, and blue. Various data formats for images include JPEG, GIF, PNG. However, the intended scope of the systems and methods disclosed herein is not limited to images. Rather, these systems and methods may be extended to any multimedia object including video files and audio files such as music files and combinations of these. The multimedia object may be encoded or compressed for storage and transmission in any suitable way. The multimedia may further included supplemental data, such as text defining a title or comments or captions which have been attached to the multimedia object. In another example, the multimedia object may have supplemental data which define ownership or following relations among users of the system. The supplemental data associated with a multimedia object may include any sort of information which it may be useful to track or monitor or store. For convenience, the descriptions and examples herein generally use images but may be extended to any multimedia object.

Images may be referenced in web pages and presented to users via web browsers. The hypertext markup language used to describe web pages to web clients includes the image inclusion construct, for example <img src=“http://www[dot].example[dot]com/sunset[dot]png” alt=“Sunset over the Grand Canyon”>. Web servers serve HTML in response to requests of web clients, typically web browsers. Images in web pages may have a context that is descriptive or indicative of their nature, including caption, meta tags of page, alt text of image, surrounding description, occurrence on page with other images.

A pin is an item including an image with data associated for its presentation, discovery and management, in a social visual system like these. A pin may include data used in its representation to a viewer, including a caption or description, data used to facilitate discovery and recommendation of the pin, including textual data and metadata from the context of the image on a web page, extracted data features of the image, such as its size, dimensions, location the image was acquired, camera type and settings, extracted visual features of the image, such as color histogram, spatial frequency distribution, quantity of faces and their sizes, text that may be computer-readable by the art of optical character recognition, patterns intended to be machine-readable representations of data, such as QR codes.

A collection is a container for a set of items, with additional properties of the collection that may include a title and description. A collection is owned by a user. A collaborative collection is a collection to which multiple users can contribute. In one embodiment, the owner of the collaborative collection invites other users to contribute to the collection. If the invited users accept the invitation, they become contributors and they may add images to the collaborative collection.

A user is a person who views content. Some users are registered with a system, have an account and are able to log in, acquiring identity and additional privileges over the unidentified user. An owner of a collection is a user who owns the collection or the user who has an account with the system and the collection is associated with the user's account. The owner-user may view his profile as a default view on a client computer or may view other user's public profiles as well. A user who views another user's profile or collections is a visitor. A user who selects to follow a user or to follow one or some of a user's collections is a follower or following user. A user who owns a collection that is followed by others is a followed user.

When a following user follows another user, the following user subscribes to any items added to the followed user's collections. When a user logs in, she views her home screen. The following user's home screen displays images of the followed user and with images of followed collections, in addition to her own images. When the followed user updates his collected images, the following user will see the updates. When a following user follows a collection, the following user subscribes to all items that are added to that collection. The following user's home screen displays images of the followed collection. When the followed collection is updated, the following user will see the updates on his screen. If the followed collection is a collaborative collection, the following user will see images added to the collaborative collection by contributors to the collection.

A stream is a sequence of items such as images or pins representing images with associated data. The sequence is established by an ordering function on the set of items in the sequence. Often, reverse time order (most recent first) is a desired ordering function. A relevance or interest score of an item can be a component of an ordering function. An economic compensation to the system operator can be a component of a selection and ordering function. The system operator may be compensated for including an item in a stream.

That compensation may be by instance that the item is presented in a stream to a user. Compensation may depend on how well the system operator selects the users to which to introduce the item. Compensation may depend on the quantity of users that take a subsequent action on an introduced item. Such compensatable actions may include a user marking the item as liked, a user entering the item in one or more of their own collections (“repinning”), a user commenting on a promoted item, a user examining the more detailed representation of an item, a user following one or more links associated with an item, which may lead the user to another web site, a user indicating interest in receiving additional information about the item and related items, a user indicating purchase interest in a product or service depicted in an item, and a user purchasing such a product or service.

Compensation may include a factor taking into account the activity of the user, the user's influence over others, which measures may include the number of other users that follow user's activities and collections, the popularity of the user's collections, the number and nature of comments others make on user's items, the number and nature of comments user makes on others items, the number and nature of items the user introduces into the system as their own items.

A system operator may employ one or more devices to select promoted items to introduce to users. Such methods may include determining the expected affinity of the user for the item, and including that expectation in combination with the economic compensation for presenting the item, in the selection process for introducing items.

Streams can be composed from other streams by various devices, including by merging the streams in time order. Streams may also be merged by taking the set union of the items in the streams and applying an ordering function. This removes duplicate items.

A user may use other functions of ordered sets to compose streams, including functions that omit certain occurrences of items that are judged by some function to be redundant or insufficiently interesting, and functions that give priority to items as a function of the importance or relevance or economics of the item and the contributing stream from which it comes.

A stream can be composed from another stream, which we may call the upstream, and a filter function, which decides, for each item in the upstream, whether it is included in the stream. Filter functions that may be employed include functions that omit items labeled or determined to be objectionable to the user, functions that omit items that the user has marked as undesirable, and functions that include only items the user has marked as having a certain attribute. In some embodiments, user may mark items as undesirable by user interface means, which include a “close” or “x-out” box in the presentation of an item, and may mark items as having a favored attribute, by user interface means that mark the item presentation with a star or thumbs up icon.

A stream can be composed from another stream, which we may call the upstream, and an annotation or transformation function, which for each item in the stream, may alter that item, including additional information on that item. Such information may include relations to other items, or external information such as links to other web pages. Such information may include indicators of the nature of the item according to some classification or labeling scheme, such as whether an item's associated link leads to a purchase opportunity, a recipe or instructions for constructing something depicted by that item, a review of something depicted by that item. Annotators may make an estimation of the item's topic nature, such as fashion, cooking, home improvement.

Item annotations may be used to alter the presentation of an item to a user, including by including or omitting an icon conveying an attribute, which icon may be presented adjacent or below the image of an item, or superimposed over the item, possibly with partial transparency.

A stream may be created from a single collection, from a set of collections, from all the collections of a user, from the results of a search or recommendation request, from the pins considered by some process to be popular overall, or popular or relevant to a particular category or search.

A user has a home stream, which in some embodiments the user sees when the user logs in. In some embodiments, the home stream includes the time-ordered merger of the streams formed from the user's collections, the collections the user can edit, and the collections the user follows, merged with one or more streams produced by recommended content processes adapted to that user, merged with one or more streams of promotional content processes adapted to that user.

In the one embodiment, the system introduces recommended content to the home stream of a user, and learns a model of what content features to which the user responds positively and negatively. The system uses that learning, in association with the relationships of users to other users, to adapt and improve the selection process of recommended content.

A user can choose to follow a collection of another user, in which case the stream of that collection contributes to the user's home stream. A user can choose to follow another user, which has the effect of following each collection of that followed user, including ones the followed user creates subsequently. A user can unfollow a collection previously followed, including a collection of a followed user.

A search may be expressed by a combination of one or more elements that may be units of text, example images, example boards, example users, which each can represent positive and negative examples.

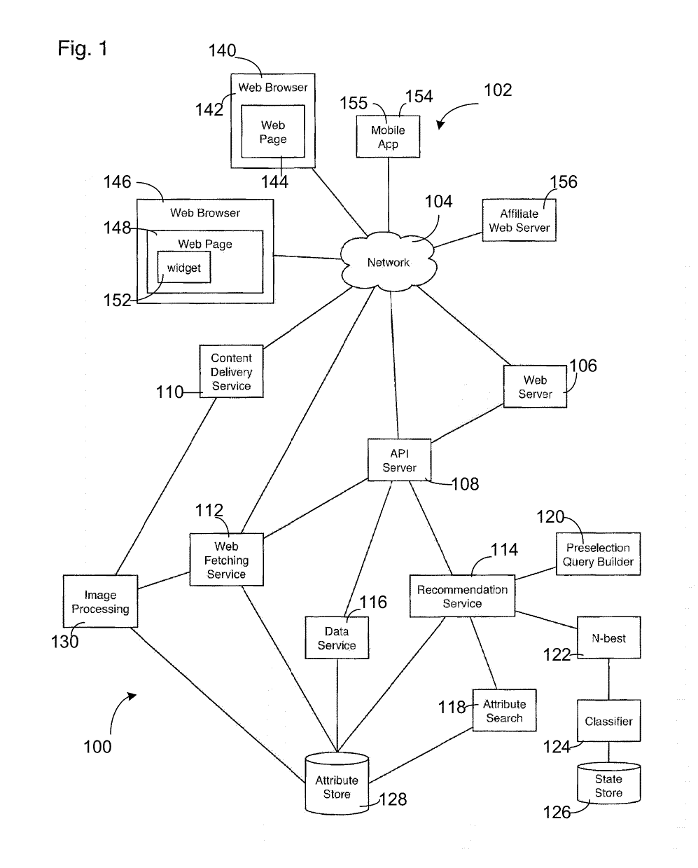

Referring now to the drawings, FIG. 1 shows an example of an operating environment for implementing a multimedia content sharing system 100. In the operating environment, a plurality of client computers 102 communicate through a network 104 with the multimedia content sharing system 100. The multimedia content sharing system 100 in the exemplary embodiment includes a web server 106, an API server 108, a content delivery service 110 and a web fetching service 112. The multimedia content sharing system 100 further includes a recommendation service 114, a data service 116, an attribute search service 118, a preselection query builder 120, an N-best selector 122, a classifier 124, a state store 126, an attribute store 128 and an image processor 130.

The API server 108 provides an Application Programming Interface for clients to access capabilities of the system, and coordinates the operation of internal services to provide those capabilities.

The client computers 102 are data processing systems operable to access the multimedia content sharing system 100. The client computers 102 include first client computer 140, second client computer 146, third client computer 154 and fourth client computer 156. Any suitable data processing system may be used for such remote access by a user operating a user interface of the client computer, and several examples are shown in FIG. 1. For example, a first client computer 140 includes a processor, memory and network interface. The processor, memory and network interface cooperate to implement a web browser 142 to view a web page 144. A web browser 142 is a software application for retrieving, presenting and traversing information resources on a network such as the World Wide Web. Information resources include, for example, web sites and individual web pages 144. Information resources further may include video information, audio information and image information.

The second client computer 146 similarly includes a processor, memory and network interface and similarly implements a web browser 148 to view a web page 150. The web page 150 in this example includes a widget 152. The widget is a portion of software code that displays information such as images within the service that are relevant to the context.

The third client computer 154 is a mobile device such as a cellular telephone, cordless telephone, smart phone, personal digital assistant, tablet computer or portable computer. Generally, the third client computer 154 is small enough and light enough to be transportable. Further, the third client computer 154 employs battery power to be portable. The third client computer 154 generally includes a processor, memory and network interface and implements an application 155 for accessing the multimedia content sharing system 100. The application may be a standalone, customized application for accessing the multimedia content sharing system 100. Alternatively, the application may be a general purpose web browser such as the web browser 148 or the web browser 142. Still further, in recognition of the limited size and capacity and functionality of a portable device, the application may be a limited-capability browser with functionality optimized for use with a mobile device.

The fourth client computer 156 in this example is an affiliate computer. An affiliate computer is operated by an affiliate organization. An affiliate organization may be any individual or organization that has an arrangement with the multimedia content sharing system 100 to provide information to the multimedia content sharing system or users of the multimedia content sharing system, or to receive information from the multimedia content sharing system or users of the multimedia content sharing system, or both. Examples of affiliate organizations include advertisers who provide advertising and other information to the multimedia content sharing system 100, content providers who provide content including images or other multimedia information to the multimedia content sharing system 100, and operators of web sites that incorporate or make use of content and behaviors of the multimedia content sharing system 100. Such exemplary advertisers and content providers may also receive information from the multimedia content sharing system 100, such as information about user actions taken by users of other client computers 102 or processed information such as information about user preferences determined by the multimedia content sharing system 100.

A user using a client computer 102 employs a web browser such as web browser 142, 148 or an application on mobile device to view web pages on an accessed web site. In general, the user may have an account with the multimedia content sharing system 100 and, as part of the user's account, may have in place a number of collections of images or other multimedia information. The user using the client computer 102 may add an image to a collection or organize her collections or view other images and other collections of other users.

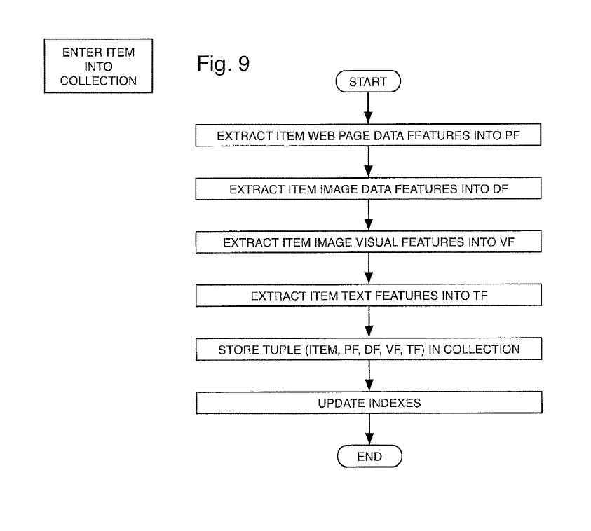

An accessed web page may include one or more images which are of interest to the user. Based on this interest, the user may choose to pin the image. The user may pin an image via a bookmarklet operating on the user's web browser. The bookmarklet is a routine which executes in the user's browser, which communicates to the web server 106 or the API Server 108 the image URL and the page URL on which the user encountered the image, and the user agent, and which identifies the browser model the user is using, along with additional data to facilitate the operation of the system. The API Server 108 in turn tells the Web Fetching Service 112 to get the image for pinning. The Web Fetching Service 112 retrieves the image using, for example, the hypertext transport protocol, and passes the image to the Image Processing Service 130 to produce a set of processed images for inclusion in the Content Delivery Service 110. The Image Processing Service 130 records the Content Delivery Service 110 URLs of the processed image products in the Attribute Store 118. By a procedure such as the procedure described below in conjunction with FIG. 9, the Image Processing Service 130 also extracts image data features and image visual features, and records them in the Attribute Store 128. The Web Fetching Service 112 also gets the page the image was on, examines it to extract web page data features, which it records in the Attribute Store 128. The Web Fetching Service 112 tells the API Server 108 the image ID and the URL of the thumbnail image in the Content Delivery Service 110, which tells the bookmarklet in the response to the image preparation request, and the collection names of the user.

The bookmarklet solicits user selection of which collection of the user shall contain the pin, and a description to use. It allows the user to create a new collection to receive the pin, in which case it communicates with the API Server 108 to create that new collection. The user can elect to place the pin in a new collection or an existing one. The user makes that election and pins the image, then bookmarklet tells API Server 108 which uses the Data Service 116 to update the Attribute Store 128 so that the collection contains the pin.

The user and other users may view collections on web pages of the operator of the multimedia content sharing system 100. The user's browser requests pages from Web Server 106, which asks the API Server 108 to provide it with information to render the collection. That info can include a title and description for the collection, and the pins within it.

Image Suggestion

In some embodiments, if the collection is alterable by a user, the web page representing that collection includes a component that shows other images or pins that the system determines may be worth the user's consideration for inclusion in the collection. The user may select one or more such items to include in that collection, at which point user may supply a description for any items selected for inclusion. Upon selection, the multimedia content sharing system 100 enters the selected pins in the collection, and provides new suggested images or pins for the collection, based on the now-expanded collection and the user's choices made in the past history of offered items selected and passed-over.

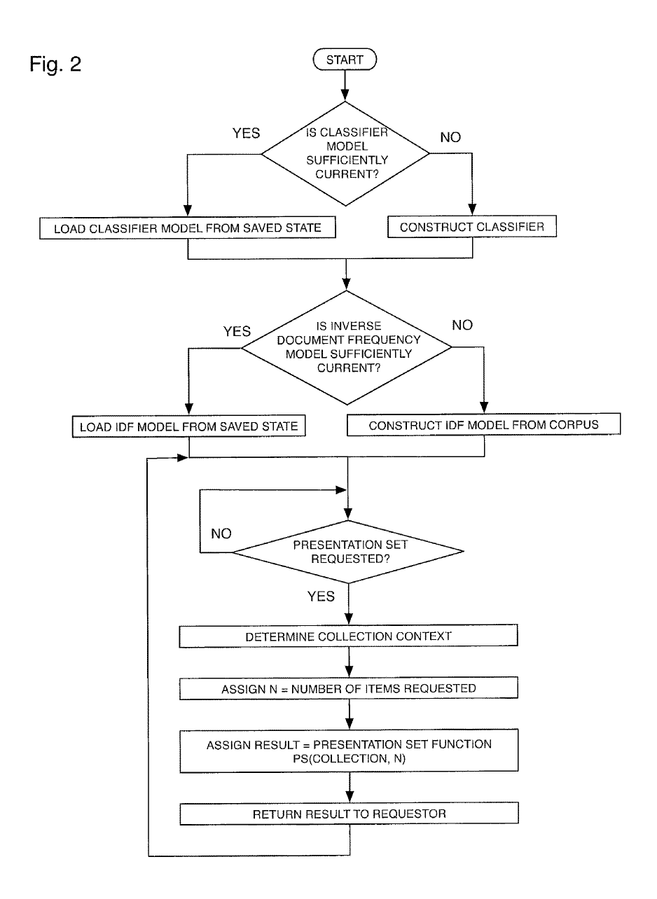

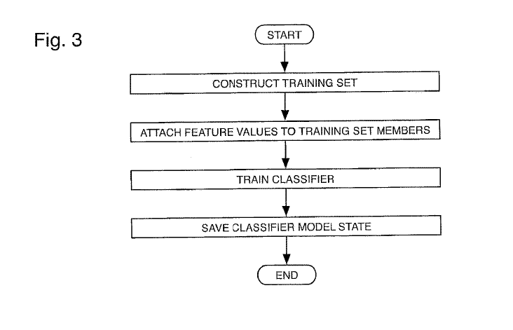

FIG. 2 is a flow diagram illustrating an exemplary process for providing suggested images to a user by the multimedia content sharing system of FIG. 1. Upon starting, the system determines if its classifier model, as stored in State Store 126 of FIG. 1 in the exemplary system, is sufficiently current. This can be accomplished by heuristic methods such as comparing the present time with the time the model was last updated, or by considering how much new content has been entered into the system since the model was last updated, or by administrative instruction from the system operator. If the model is sufficiently current, the classifier model is loaded from State Store 126 of FIG. 1, otherwise it is constructed or updated, for example by the method of FIG. 3.

After loading the classifier model, the exemplary system proceeds as shown in FIG. 2 to determine if its inverse document frequency (IDF) model is sufficiently current. This determination may be made by analogous means to those used to decide the currency of the classifier model. As a result of that determination, the IDF model is either loaded from saved state, or constructed from the corpus and saved. Once this is done, the system is ready to accept requests for presentation sets of content.

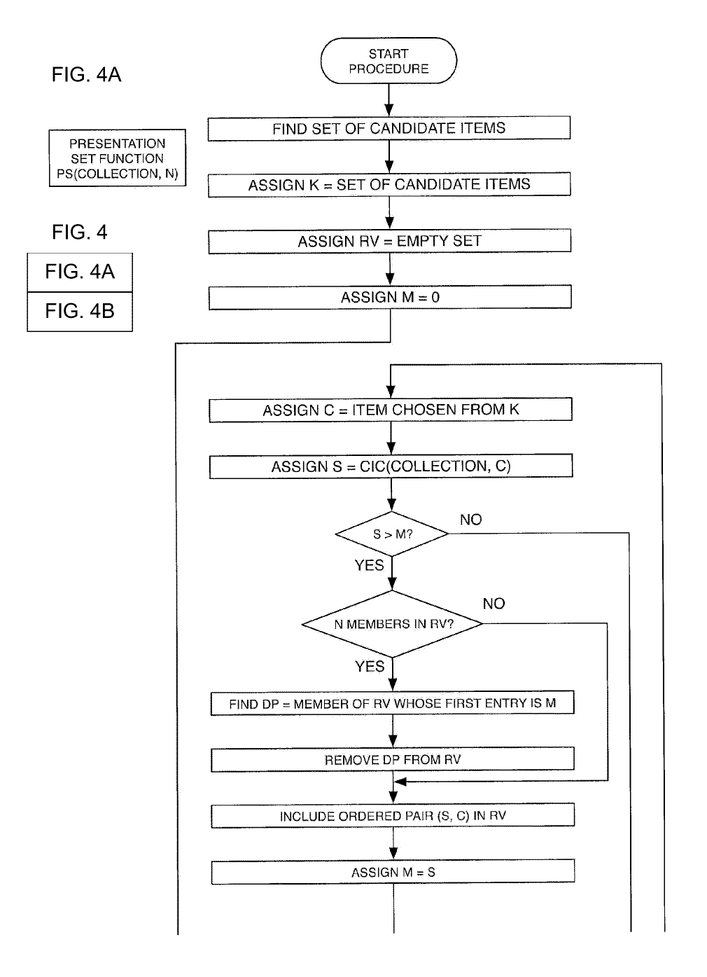

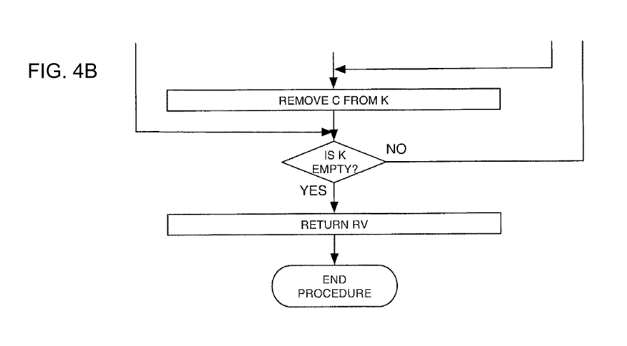

When a presentation set is requested, the method of FIG. 2 proceeds by determining the context of the multimedia collection, and employs the method of FIG. 4 to arrive at a presentation set, which it returns to the requesting method or component of the system, which in the exemplary system is the API Server 108 of FIG. 1.

FIG. 3 shows an exemplary method for constructing a classifier model as used in the method of FIG. 2 and appearing in FIG. 1 as Classifier 124. It proceeds by constructing a training set to train a standard classifier as known in the art of machine learning. One such example is a gradient descent classifier, for instance Vowpal Wabbit. The method of FIG. 3 then determines and attaches feature values to the members of the training set, and trains the classifier. This results in an altered state of the classifier, which contains the learned classification ability. This state is saved in the State Store 126 of FIG. 1, from which it can be reloaded into the classifier subsequently.

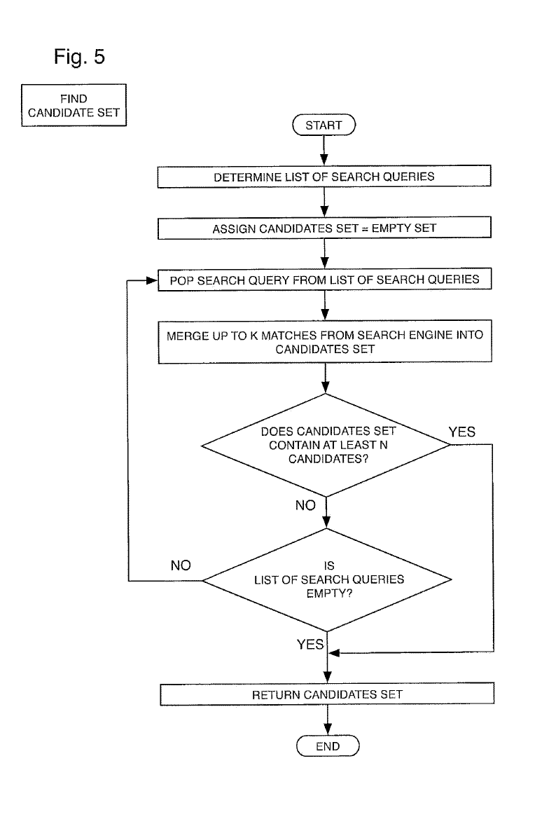

FIG. 4 shows an exemplary method for determining the presentation set used by the method of FIG. 2. In the drawing, FIG. 4 is presented as two connected figures, FIG. 4A and FIG. 4B. The method of FIG. 4 first finds a set of candidate items, exemplified by the method of FIG. 5. Set variable K is used to hold that candidate set. A variable RV which can contain a set of ordered tuples is initialized to the empty set. An integer variable M is initialized to zero.

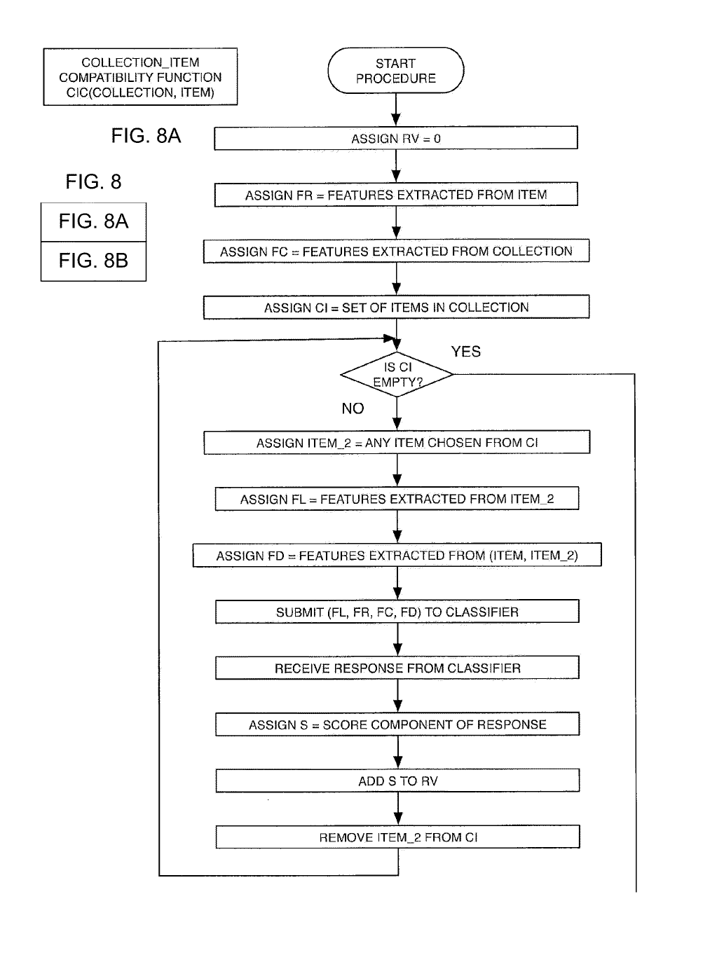

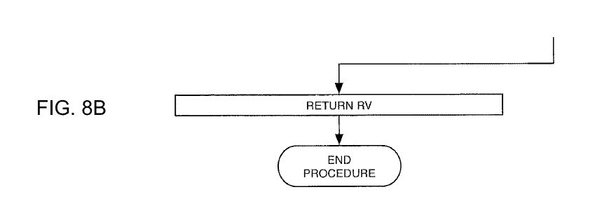

The method of FIG. 4 then proceeds by checking if set K is empty. If it is, the method returns the set in RV, and the procedure ends. If K is non-empty, it proceeds to assign an item chosen from K to the item variable C. It then uses the method of FIG. 8 to determine the scalar value of the collection-item compatibility as between the subject collection, and the candidate item C, assigning that scalar compatibility value to variable S. S is then compared with M. If S is less than or equal to M, the method advances to remove item C from candidate set K. It then determines if set K is empty. If K is non-empty, the method goes back and again assigns an item from K to C, thereby bringing a new candidate into consideration, and the method proceeds to determine the collection-item compatibility as between the subject collection and the new candidate in C, assigning that value to variable S. Again S is compared to M. If S is greater than M, the method proceeds to determine if RV contains N members. If it does, the variable DP is set to the member of RV whose first entry in the tuple is M, and that member is removed from RV, thereby making room for the superior candidate C without exceeding the desired cardinality N. If RV does not contain N members this removal operation is skipped. The method then proceeds to include the ordered pair (S, C) in the set RV, assign variable M to the value in variable S, and remove candidate C from candidate set K. If K is empty, all the candidates have been examined and the set RV is returned, ending the procedure.

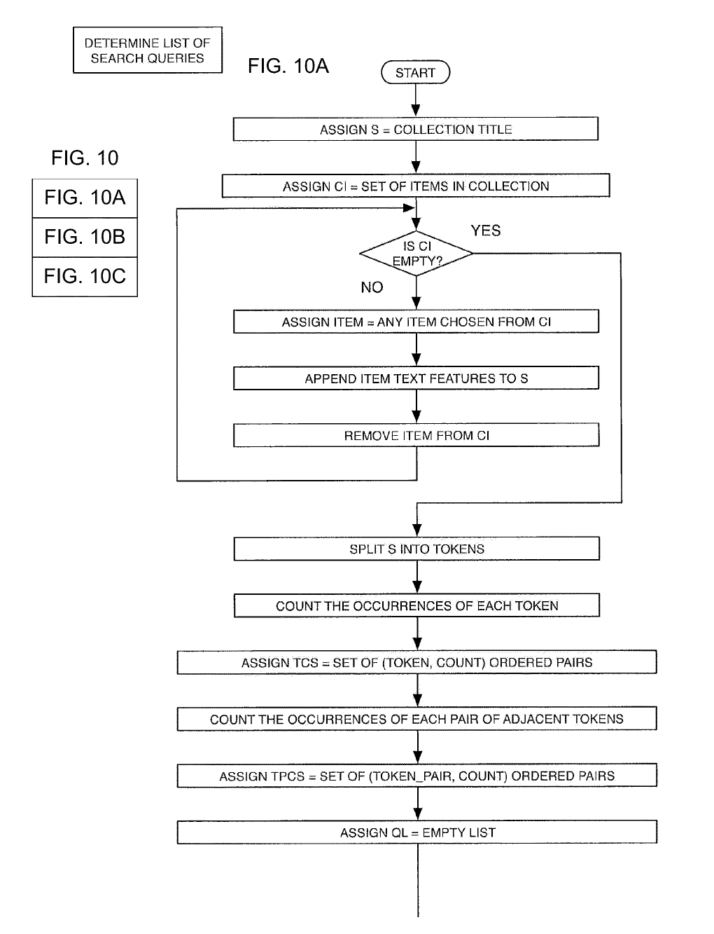

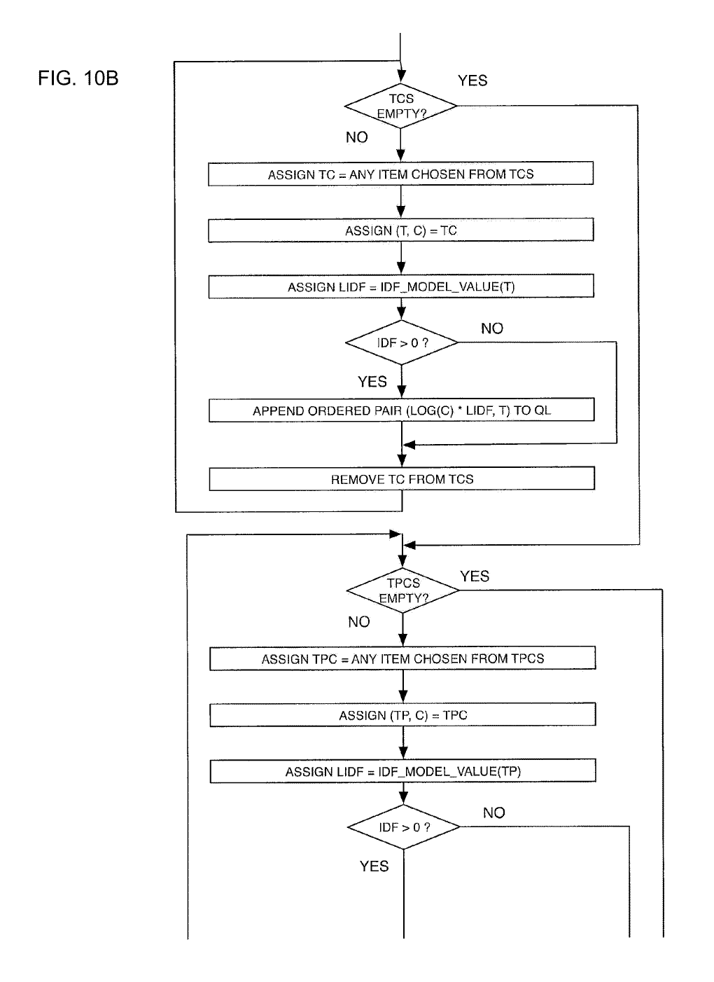

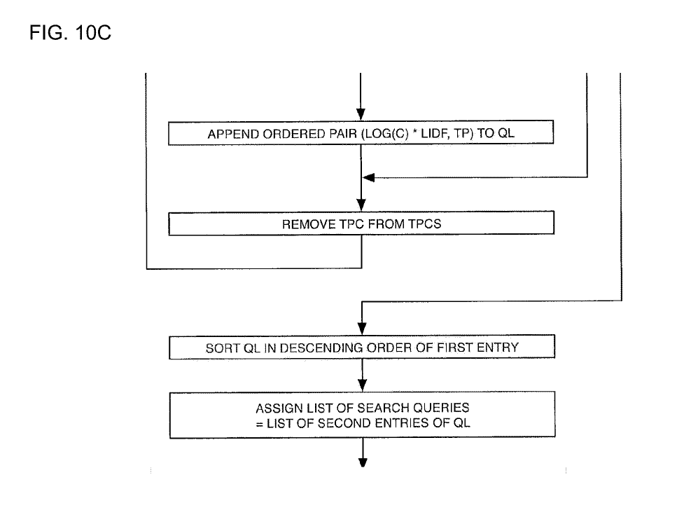

FIG. 5 shows an exemplary method of finding a candidate set of media items, as employed in the method of FIG. 4. The method of FIG. 5 proceeds by determining a list of search queries, for example by the method of FIG. 10. The method then initializes the candidates set to the empty set, and proceeds to pop a search query off the list of search queries. The method uses that search query to find up to K matches from the search engine, and merges them into the candidate set, eliminating duplicates. The cardinality of the candidate set is then checked to see if it has at least the desired N candidates. If it does not, the list of search queries is checked. If that list is not empty, the next search query is popped off, that search performed, and up to K matches merged in to the candidates set as before. Once the candidates set contains at least N candidates, or if not, when the search queries are all consumed, the candidate set is complete and it is returned.

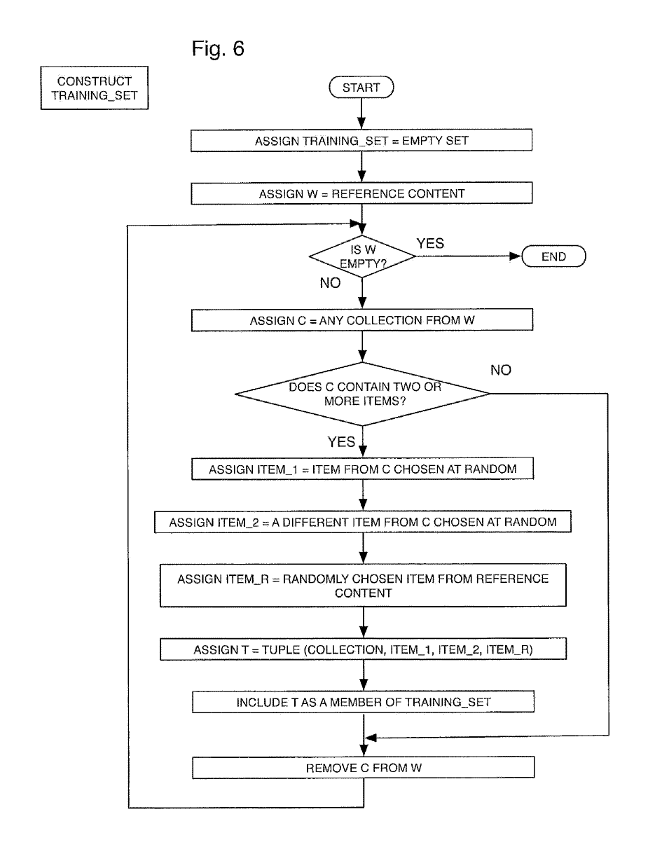

FIG. 6 shows an exemplary method of constructing a training set for a classifier system component 124 of FIG. 1, as used in the classifier construction method of FIG. 3. At the start, the training set is assigned the empty set, and set variable W is assigned the reference content. If W is non-empty, a collection from W is assigned to the variable C. If C contains two or more items, an ITEM_1 variable is assigned an item from C chosen at random, and an ITEM_2 variable is assigned a different item from C chosen at random. A third item variable, ITEM_R, is assigned a randomly-chosen item from the reference content. A tuple variable T is assigned the ordered quadruple (Collection C, ITEM_1, ITEM_2, ITEM_R). Tuple T is then included as a member of the training set, and collection C removed from W, and the method loops back up to test if W is empty. If W is still non-empty, another collection from W is assigned to C. If that collection contains zero or one items, it is not able to provide the required two items ITEM_1 and ITEM_2, in which case the method proceeds directly to removing C from W, and again testing if W is empty. Once W is emptied by the successive removal of the candidate collections, the training set is complete and the method of FIG. 6 is complete.

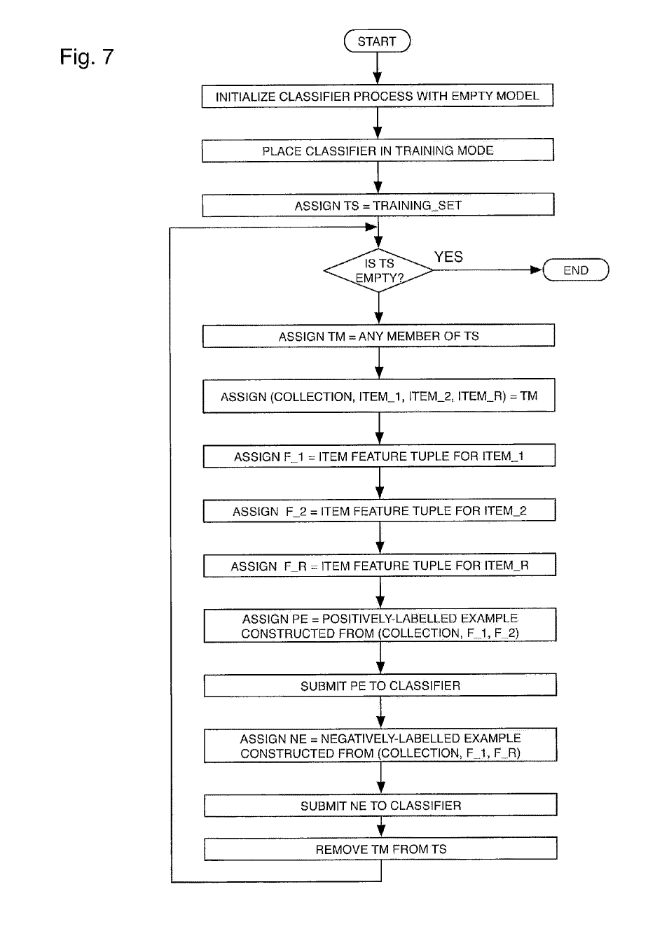

FIG. 7 shows an exemplary method of creating feature-labelled positive examples and negative examples for the training the classifier as performed in the method of FIG. 3. It starts by initializing the classifier process with the empty model, and placing the classifier in its training mode. The set variable TS is assigned the training set, which may be constructed by the method of FIG. 6. In outline, the method of FIG. 7 proceeds to use each member of the training set to construct both a positive example and a negative example, which are submitted to the classifier in its training mode. In detail, if TS is non-empty, variable TM is assigned any member of TS, and the constituent items of its tuple, that is, (COLLECTION, ITEM_1, ITEM_2 ITEM_R) are accessed from TM. Variable F_1 is assigned the item feature tuple of features extracted from ITEM_1. Likewise variable F_2 is assigned the item feature tuple of features extracted from ITEM_2, and F_R likewise for ITEM_R. Positive example PE is constructed from the tuple (COLLECTION, F_1, F_2) and submitted to the classifier. Likewise, negative example NE is constructed from the tuple (COLLECTION, F_1, F_R) and submitted to the classifier as a negative example. TM is then removed from TS, and the method again checks if TS is now empty. It continues by this process until the training set has all been consumed and the classifier fully trained.

FIG. 8 shows an exemplary method for determining the compatibility of an item to a collection, as used in the method of FIG. 4. In the drawing, FIG. 8 is presented as two connected figures, FIG. 8A and FIG. 8B. This method starts by assigning a scalar variable RV the value zero. It assigns to tuple variable FR the features extracted from the item, and to tuple FC the features extracted from the collection. Set variable CI is assigned the set of items in the collection. Until CI is empty, the method proceeds as follows. Variable ITEM_2 is assigned any item chosen from the set of items in CI, and FL the features extracted from ITEM_2. Tuple variable FD is assigned the features extracted from (ITEM, ITEM_2). The tuple (FL, FR, FC, FD) is submitted to the classifier for scoring. The score from the classifier's response is added to RV, and ITEM_2 removed from CI. Once all the items of the collection have been consumed by this process, RV is returned.

FIG. 9 shows an exemplary method of entering a multimedia item into a collection. The item's containing web page data features are extracted into variable PF. Such page data features may include the URL, the page title, the page text, the links to and from the page, for example. The item's image data features are extracted into variable DF. Image data features may include the image dimensions in pixels, the size of the image data, the file format, metadata in the file such as geolocation, camera model, camera settings, compression settings, user annotations, and so forth, by way of example. The item's visual features are extracted into variable VF. Such visual features may include the color histogram, the spatial frequency distribution of the image, the brightness of the corners and the center, the number and sizes of faces in the image, the apparent emotional state and relationship of the people in the image, their gender, their dress, and whatever other features are computationally achievable that prove useful to the operation of the system. The item text features are extracted into variable TF. Those features may include the URL of the image, any HTML “alt” text associated with the image, any URL for which this image is included as an anchor, and other text included in that anchor. The tuple (ITEM, PF, DF, VF, TF) is then stored in the collection, and the indexes are updated, typically by incremental means as known in the art.

FIG. 10 shows an exemplary method of determining a list of search queries, as used in the method of FIG. 5. In the drawing, FIG. 10 is presented as three connected figures, FIG. 10A, FIG. 10B and FIG. 10C. This method starts by assigning the title of the collection to text variable S. Then the text features of every item in the collection are concatenated onto S. S is split into tokens, for example at whitespace, and the occurrences of each token are determined. Those occurrences are used to assign variable TCS the set of (token, count) ordered pairs from tokenizing S. The occurrences of each pair of adjacent tokens is also determined, and these bigrams are counted to assign variable TPCS the set of (token_pair, count) ordered pairs.

Next the list variable QL is initialized to the empty list. While the TCS set is non-empty, tuples are removed from it one at a time and the Inverse Document Frequency model value of the token T from the tuple is assigned to the variable LIDF. If that value is greater than zero, the tuple formed from the product of the log of the count of token occurrences and LIDF as the first element, and the token as the second element, is appended to QL. The same process is performed on the bigram counts set TPCS.

Once these token and bigram counts have been converted and appended to QL, they are sorted in descending order of their first entry, and the list of queries themselves, the second element of each tuple in QL, are returned in order, as the list of search queries. The system may also employ methods to construct a search query from the current contents of the collection. That search query may be used to obtain a set or list of other pins within the system to proffer to the user. That search query may be constructed by transformations of attributes of the collection, such as the title of the collection, the date it was created, and attributes of the items within the collection, including the sequence and times the objects were placed in the collection, information from the context in which the objects were selected, such as any attributes such as search terms of searches that produced the object or contents from which the object was constructed, any titles, descriptions, comments, likes and dislikes the objects may have, the source of those titles, descriptions, likes and dislikes, including information about the users who associated the titles and descriptions with the objects likes and dislikes, information from or about the web pages or other sources from which the image was obtained, as well as such information about objects containing similar images or from similar origins.

That search query may also be used to query systems other than ones operated by the system operator. By way of example, it may be used to query image search engines such a Google Images, Bing, image metasearch engines such as Pictures.com. The search query used at each such search service may be adapted to that service to improve the results obtained from that service and the overall results of the ensemble. The search query may include restricting the results obtained to certain sources the system has determined are likely to produce results that please the user, for example, to web sites whose images are generally well-received.

The results from querying internal and external systems may be presented within the same web page that presents the collection, or within one or more frames within such pages, or in separate windows, or frames within separate windows. Search results may be selected by the user to include in one or more collections by various means, including clicking on the image or other target associated with the result, dragging the result to some drop target.

The system may provide the user with further means to alter or improve the set of proffered objects (images), which may include means for the user to disfavor or disclude one or more results from the proffered set. Such discluded offerings may be replaced by others. The system may respond to such negative indications by changing other proffered objects. It may use such indications to modify the form of the search query, perform that modified search, and proffer a possibly-different set of objects, with a possibly-different arrangement in their presentation.

Collection Display and Organization

In accordance with some of the disclosed embodiments, the present system and method are configured to display on a client computer a variety of views of information within the multimedia content sharing system. The view provided to the client device is displayed on a user interface of the client device. For example, if the client device is a laptop or desk top computer, the view is displayed on the computer display. If the client device is a mobile device such as a smart phone, the view is displayed on the display screen of the mobile device. The view is provided to the client device by communicating information such as data to the client device to cause the client device to produce the view on the computer display or display screen. In this regard, the communicated information may be tailored to the client device, such as by sending reduced amounts of data or sending data in different formats when the client computer is a mobile device with a reduced size display.

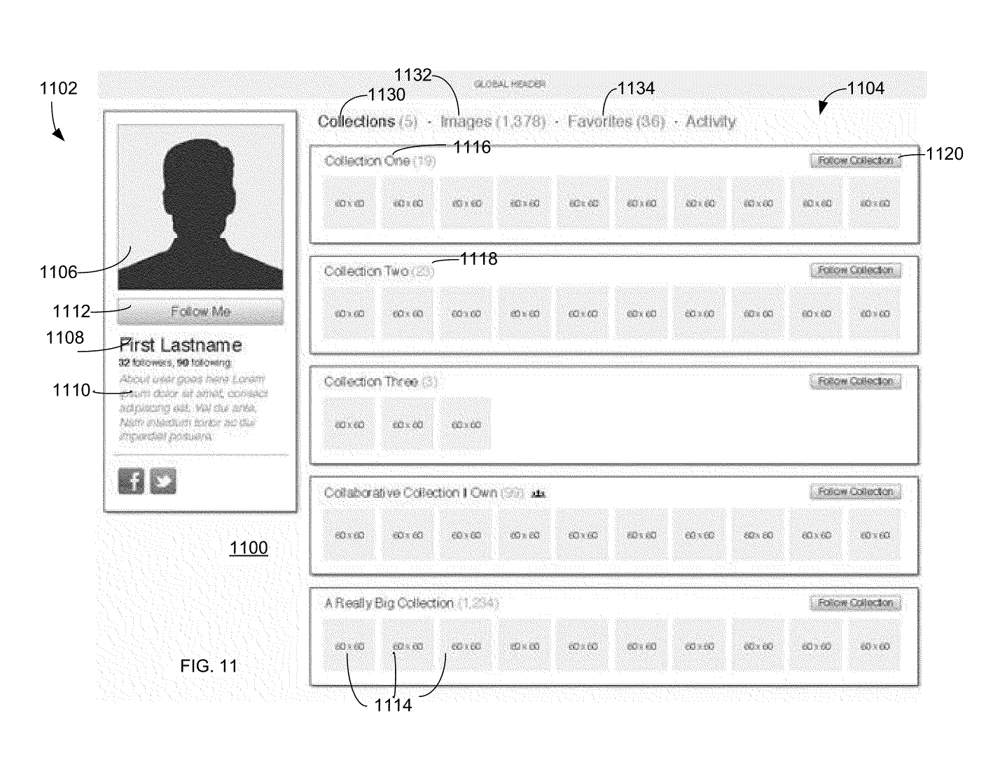

The views produced by the multimedia content sharing system for the client computer are responsive to factors such as the nature of the viewer of the client computer and the user who owns the profile, images or collection being viewed. For example, the produced view will differ if the viewer is a registered user or is a follower of the user whose profile is being viewed, or if the viewer is a contributor to the collection being viewed. FIGS. 11-16 are examples of some views that the multimedia content sharing system may produce for the viewer.

FIG. 11 is an example profile-visitor view that may be displayed to a user of the multimedia content sharing system of FIG. 1. The view shows a screen shot of an example profile view 1100 that may be shown to a visitor viewing a profile of a user of a multimedia content sharing system such as the multimedia content sharing system 100 of FIG. 1. In this example, the viewer is not following the user or any of the user's collections. Only collections which are designated as pubic by the user are visible to the viewer.

The profile view 1100 includes a profile 1102 of the user and a display of his collections 1104. The profile 1102 may include the photo 1106, name 1108 and greeting text 1110. The profile 1102 further includes a follow me button 1112. By actuating the follow me button 1112, for example, by using a computer mouse to highlight and click on the follow me button 1112, the visitor becomes a follower of the user whose profile 1102 he is currently viewing. Being a follower means that when the user updates his collections by adding to them or reorganizing them, the following visitor will be advised of the update. For example, the home page view of the visitor may include a text or graphical notification, or copies of the updated images may be added to the home page view of the visitor. Any other sort of notification of the update may be made.

The collections 1104 of the profile view 1100 include all publicly displayable collections of the user. Each collection 1104 includes one or more multimedia content items such as images 1114. Each image 1114 is a thumbnail view of the actual image contained in the collection. A thumbnail is a reduced size version of the actual image, suitable for displaying with a number of other images. For example, in the illustrated embodiment, each thumbnail view is 60×60 pixels in size while the actual image may be much larger.

In addition to the images 1114, each collection includes a title 1116 and a count 1118 of the number of images or other multimedia content items contained in the collection. The title 1116 is established by the user at the time the collection is created and may be updated. In the example of FIG. 11, the first listed collection has a title Collection One and a count of 19 items. The second listed collection has a title Collection Two and a count of 23 items.

Each collection further includes a follow collection button 1120. By actuating the follow collection button 1120, the visitor becomes a follower of the collection. Subsequently, any time the followed collection is updated, the follower will be advised of the update. For example, the home page view of the visitor may include a text or graphical notification, or copies of the updated images may be added to the home page view of the visitor. An update to the followed collection may include adding multimedia content items such as images to the followed collection, rearranging items, editing the items such as adding a text description or a title to the item or selecting an item as a favorite.

Summary information is provided near the top of the profile view 1100. In the illustrated example, the summary information includes a count 1130 of collections 1114, a count 1132 of images in the collections 1114, and a count 1134 of items designated as favorites in the collections 1114.

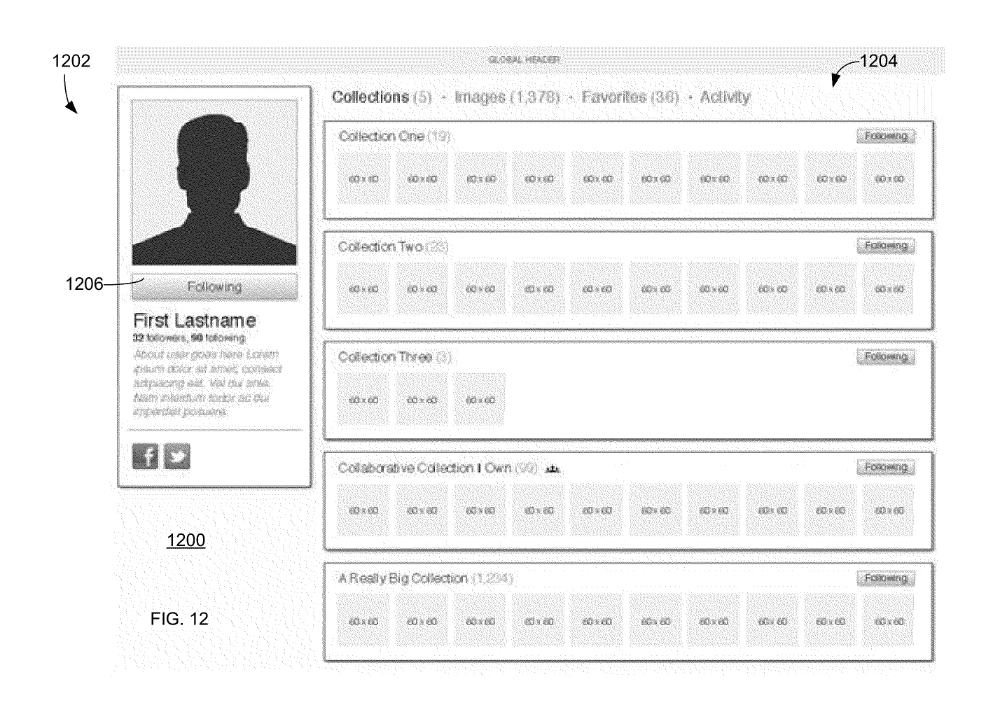

FIG. 12 is an example profile-follower view 1200 that may be displayed to a user of the multimedia content sharing system of FIG. 1. In FIG. 11, if the non-follower visitor selects the follow me button 1112 of the profile 1102, the visitor becomes a follower of the user. In FIG. 12, the profile view 1200 includes a profile 1202 and collections 1204 of the followed user. In the profile 1202, the follow me button 1112 of FIG. 11 has been updated to a following indicator 1206, indicated that the user viewing the view 1200 is following the user whose profile 1202 and collections 1204 are displayed. Following the user means that the viewer is following all of the user's collections 1204. As each collection is updated, the viewer will be advised of the update. For example, if the user adds images to one of the collections 1204, the viewer will subsequently be advised of the added image. If the user deletes one or more images, the viewer will be advised of the update. If the user rearranges images in the collections 1204, the viewer will be advised of the update. Generally, the contents of the profile view 1200 match those of the profile view 1100 of FIG. 11.

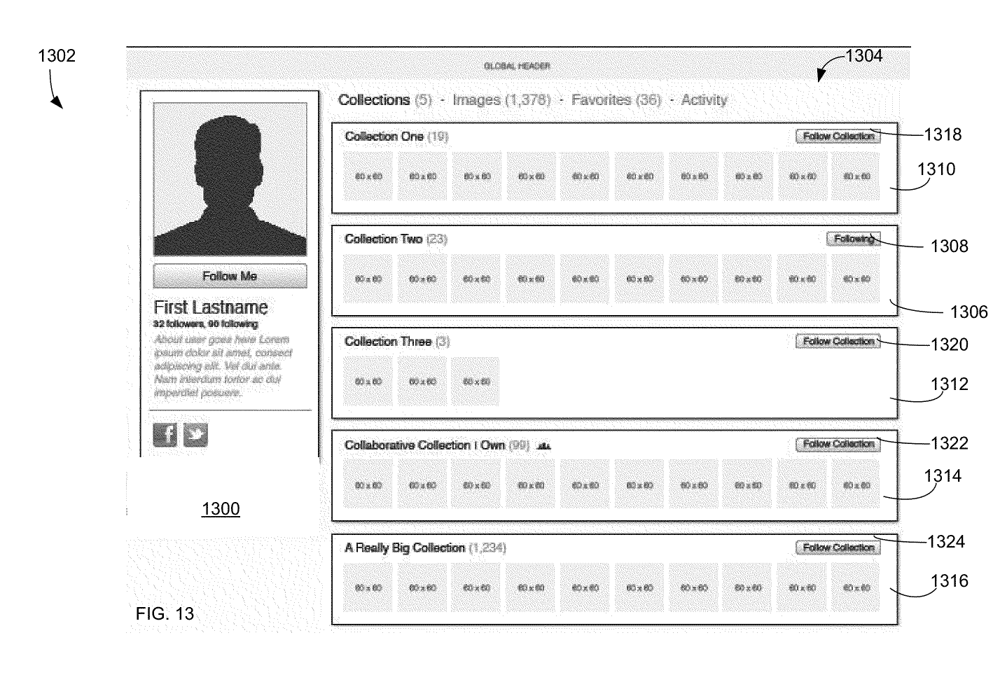

FIG. 13 is an example profile collection-follower view 1300 that may be displayed to a user of the multimedia content sharing system of FIG. 1. In FIG. 13, the profile view 1300 includes a user profile 1302 and collections 1304 of the user. Of the collections 1304, one collection 1306 has been selected to be followed by the viewer. This is made clear by the following indicator 1308 associated with the followed collection 1306, which is highlighted by the text “following” to indicate clearly the status of followed collection. The remaining collections of the user's collections 1304 are not being followed, including collection 1310, collection 1312, collection 1314 and collection 1316. The non-followed status of these collections is indicated by the follow collection buttons 1318, 1320, 1322, 1324 of the respective collections 1310, 1312, 1314, 1316. Any other device may be used to indicate that the followed collection 1306 is being followed, such as by changing the shading of the of the following indicator 1308, or changing its color or any other visual change.

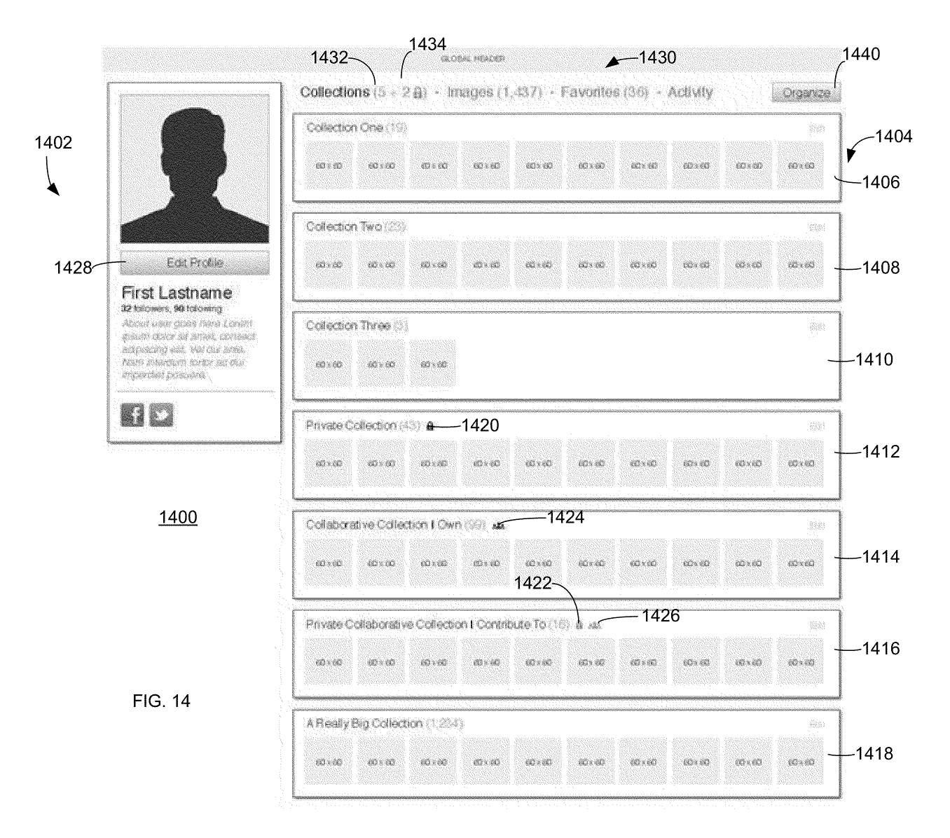

FIG. 14 is an example profile-owner view 1400 that may be displayed to a user of the multimedia content sharing system of FIG. 1. The owner view 1400 includes the owner's profile 1402 and the owner's collections 1404. The owner view 1400 is a view that may be shown to the owner of the collections 1404 as she views her collections or as she begins interaction with the multimedia content sharing system. The owner view 1400 of FIG. 14 may be the default view present to the user who owns the collections.

The owner view 1400 shows to the owner all of her collections 1404, including those which she had marked as public and those which she has marked as private, as well as those which she owns solely and those to which she is a contributor. The collections 1404 include public collections 1406, 1408, 1410, 1414 and 1418. Further, the collections 1404 include private collections 1412 and 1416. The private status of the private collections 1412, 1416 is indicated by a lock indicator 1420, 1422 displayed in the strip of collections 1412, 1416, respectively. In the embodiment of FIG. 14, the lock indicator 1420 is a stylized lock symbol suggesting a private or non-public nature of the collections 1412, 1416. However, any other suitable lock indicator may be used to indicate the private or non-public nature of specified collections. A locked or private collection is one that can be viewed only by the owner of the collection or contributors to the collection.

Moreover, the lock indicators 1420, 1422 further indicate the collaborative nature of the respective collections, 1412, 1416. In the strip of the collection 1412, the lock indicator 1420 is a solidly colored black lock symbol. In contrast, in the strip of the collection 1416, the lock indicator 1422 is shaded light gray. The solid black lock indicator 1420 indicates that the collection 1412 is a private collection owned by the viewer. The shaded gray lock indicator 1422 in the strip of the collection 1416 indicates that the collection 1416 is a private collection where the user is a contributor.

Similarly, the collection 1414 includes a collaboration indicator 1424 and the collection 1416 includes a collaboration indicator 1426. The collaboration indicators 1424, 1426 indicate that the collections 1414, 1416 are collaborative, meaning that they are defined so that more than one owner may contribute to the collection by adding images, editing images or deleting images, or otherwise maintaining the collections 1414, 1416. The collaboration indicator 1424 is solid black to indicate that the collection 1414 is a collaborative collection for which the viewer is the owner. The collaboration indicator 1426 is shaded gray to indicate that the collection 1416 is a collaborative collection where the viewer is a contributor, rather than the owner of the collection.

In FIG. 14, the profile view 1400 displays the owner's profile for editing. To that end, the owner's profile 1402 includes an Edit Profile Button 1428. By actuating the Edit Profile Button 1428, the user is given the opportunity to change the contents or appearance of his profile 1402.

In FIG. 14, the profile view 1400 includes a status bar 1430. The status bar includes a collections count 1432 which, in the profile view 1400, shows the number of unlocked or public collections 1434, which has a value of 5 for the exemplary embodiment of FIG. 14, and the number of locked or private collections 1436, which has a value of 2 in the exemplary embodiment of FIG. 14. Adjacent to the status bar 1430, the profile view 1400 further includes an organize button 1440 which may be used to enter an organization mode for organizing the user's collections.

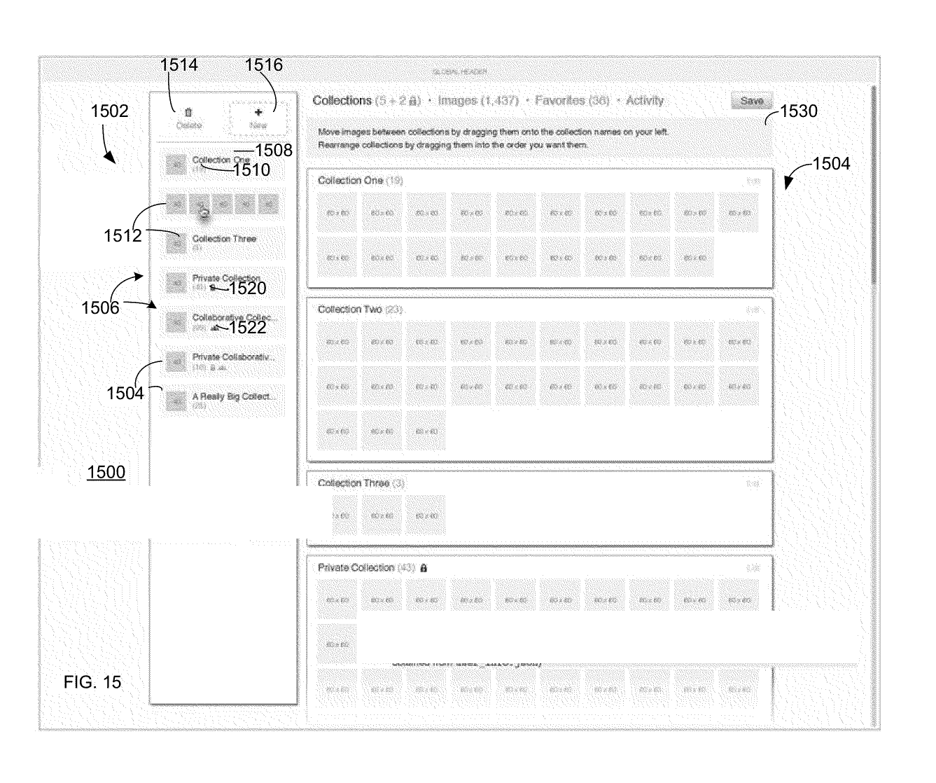

FIG. 15 is an example profile-owner view 1500 with collection organization activated, that may be displayed to a user of the multimedia content sharing system of FIG. 1. In the view 1500 of FIG. 15, the owner of the collections has activated organization mode of her own collections. This mode may be entered or activated, for example, by actuating the organize button 1440 of the profile view 1400 of FIG. 14.

In the organization mode, the view 1500 includes two views of the owner's collections. These include in this example a compact view 1502 and an expanded view 1504. The compact view 1502 displays the collections as a series of strips 1506 grouped on the left hand side of the screen. Each of the strips 1506 displays the name 1508 of the collection (such “Collection One), the count 1510 of images contained in the collection (such as 19 images for Collection One) and thumbnails 1512 of some of the images contained in the collection. In organization mode, drag and drop features become enabled so the user can conveniently organize the collections and their elements in a simple, straightforward manner.

By clicking on a collection, that collection becomes selected for additional activity. Selection may be indicated by changing the background color around the collection or by otherwise highlighting the collection's appearance.

The compact view 1502 of the collections includes a delete collection button 1514 and a new collection button. When one or more collections have been selected by the user, actuation of the delete collection button deletes the selected collection or collections from the user's profile. An undo function may be provided for the user to reconsider and backtrack from the delete operation. The new collection button 1516 opens a new strip 1506 among the compact view 1502 and invites the owner to give the new collection a title and set access permissions for the new collection.

The compact view 1502 also displays information about private or public status of each collection as well as status as a collaborative collection. Thus, as in the exemplary embodiment of FIG. 14, collections which are private are shown with a lock symbol 1520 to convey this status. Collections which are collaborative are shown with a group symbol 1522 to convey this status. As in FIG. 14, the displayed lock symbol 1520 or group symbol 1522 is shown with black shading if the current user is the owner of the collection or with gray shading if the current user is not the owner of the collection.

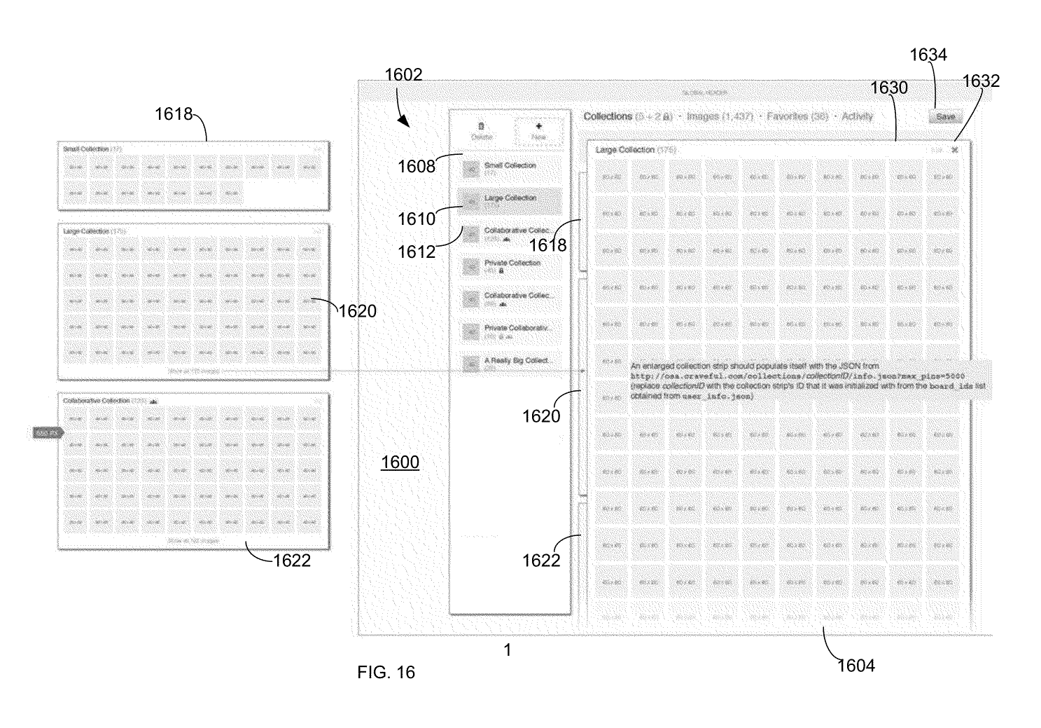

In the expanded view 1504 of the collections, the image contents are expanded to show up to 50 images in each collection. This limit may be varied depending on implementation. Further description of the expanded view 1504 will be provided below in conjunction with FIG. 16.

When the organization mode is activated, a message box 1530 appears with instructional text about what the user can do in the organization mode. In the exemplary illustration of FIG. 15, the user is invited to “Move images between collections by dragging them onto the collection names to your left. Rearrange collections by dragging them into the order you want them.” In other examples, instead of or in addition to instructional text, the message box 1530 might provide status information. Examples include “8 Images were deleted (Undo),” which reports an action the user has taken and provides a link to reverse or undo the action, and “36 Images were moved to the collection A Really Big Collection (Undo).”

FIG. 16 is an example profile-owner view 1600 with collections expanded for organization that may be displayed to a user of the multimedia content sharing system of FIG. 1. The profile view 1600 shows a compact view 1602 of the owner's collections along with an expanded collection view 1604 of a selected collection 1610 labeled Large Collection.

The compact view 1602 shows compact views of collection 1608 titled Small Collection; collection 1610 titled Large Collection; and collection 1612 labeled Collaborative Collection, along with other collections. To the right of the compact view 1602, expanded views of the respective collections are presented. The expanded views include an expanded view 1618 of the collection 1608 titled Small Collection; expanded view 1620 of the collection 1610 titled Large Collection; and expanded view 1622 of the collection 1622 titled Collaborative Collection. The expanded collection view 1604 of the collection 1610 titled Large Collection is opened as a sheet in front of or above the other expanded views 1618, 1620, 1622 of the collections 1608, 1610, 1612, respectively.

The collections in the view 1600 include the summary information described above in conjunction with FIGS. 14 and 15. Thus, collection 1610 titled Large Collection is shown in expanded collection view 1604. The collection 1610 is indicated to include 175 images. This same information is repeated for the expanded view 1620 and the expanded collection view 1604. Similarly, collections that are private include a lock symbol and collaborative collections include a group symbol.

As noted, collection 1610 includes 175 images. Such a large number of images takes up most of the profile view 1600 to display. In order to display as many thumbnail images of the collection 1610, the expanded view 1604 of the collection 1610 opens in a sheet 1630 which is displayed on top of or in front of the other expanded views of the other collections. A scroll bar may be included at the side of the sheet 1630 to allow easy scrolling among the images of the expanded collection view 1604. After viewing and editing images of the expanded collection view 1604, the user may exit by clicking an exit marker 1632 at the upper corner of the sheet 1630. In some embodiments, clicking anywhere outside the sheet 1630 closes the sheet 1630 and re-displays the full expanded view of the collections. After editing her collections, the user may click the save button 1634 and save the edits and the new updated state of her collections.

Drag and Drop Editing with a Web Browser

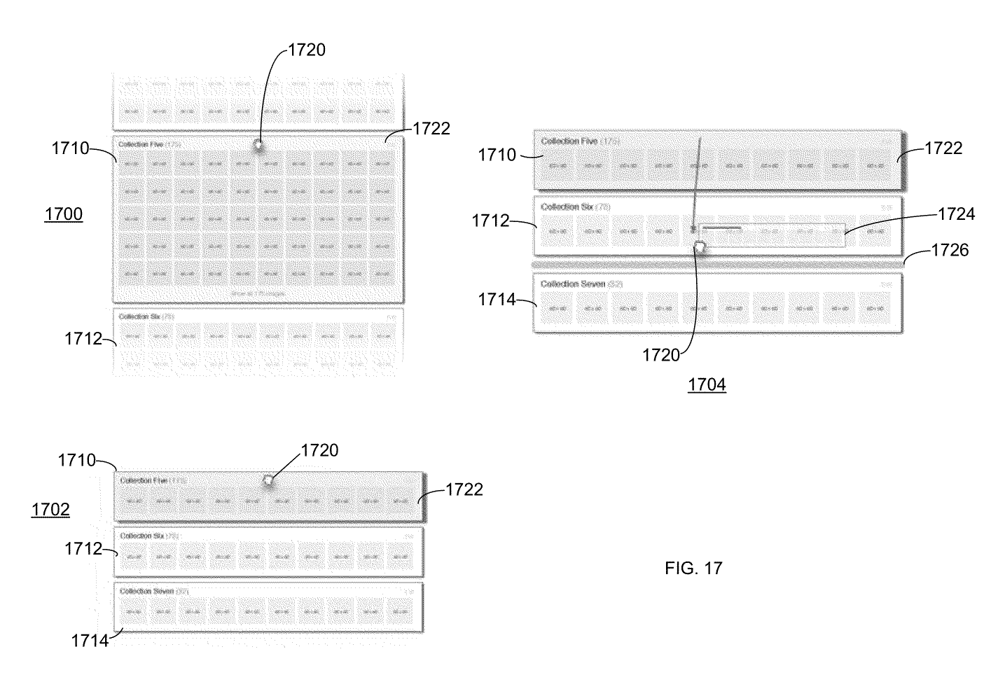

FIG. 17 is an example showing dragging and dropping of collections in a web browser that may be displayed to a user and performed by the user of the multimedia content sharing system of FIG. 1. FIG. 17 shows view 1702, second view 1704 and third view 1706 of a drag and drop process for reorganizing a user's collections.

Drag and drop processes have been used in the past as part of an operating system. For example the Macintosh operating system and the Windows operating system allow a user to view files and folders managed by the operating system either as textual names or symbols such as icons. The user may manage the files by dragging and dropping them to different locations. In general, using a mouse or other pointing device, the user moves an on-screen cursor to an object to be moved. By depressing a button on the mouse, or clicking on the object, the object is selected. The object may be a file, a group of files, a folder, a group of folders, or other objects which the operating system can manipulate. While holding down the button, the mouse is moved and the object moves across the screen. The object is thus dragged. When it reaches the desired location, the mouse button is released and dropped. If the object is dropped over a destination such as an icon representing a folder, a disk drive or a trash can, the file or group of files represented by the objected is moved by the operating system to that destination. Heretofore, drag and drop features have only been available as part of an operating system. In the present application of moving images and other multimedia files among collections displayed on a browser, using drag and drop features provides an unexpected advantage of using intuitive metaphors. On such metaphor is manually moving images around on a table top. Drag and drop interactions mimics this well from a user's perspective. In contrast, conventional browser interaction of clicking links and actuating popup menus to interact with the user interface is not inherently intuitive and does not in any way match the user's experience offline of managing objects such as pictures. The drag and drop features provide substantial convenience and ease of use, especially for new users of the system.

Each of views 1700, 1702, 1704 shows collection cards of a user's collection. In organization mode as illustrated, each of the collections is expanded to show, for example, the first 60 images in each collection. In the illustrated example, the user has a first collection card 1710 titled Collection Five; a second collection card 1712 titled Collection Six; and a third collection card 1714 titled Collection Seven. In the example, Collection Five on first collection card 1710 is initially positioned above Collection Six on the second collection card 1712, which in turn is positioned above Collection Seven on the third collection card 1714. The user seeks to reorder his collection cards so that Collection Five on the first collection card 1710 is moved to be positioned between Collection Six on the second collection card 1712 and Collection Seven on the third collection card 1714.

Initially, in view 1700, the user moves the cursor 1720 over the first collection card 1710. In accordance with the present example, in response to moving the cursor 1720 over the first collection card 1710, a background region 1722 of the collection card 1710 changes to a different appearance to highlight the collection 1710. For example, the color of shading of the background 1722 may change to a different color or a different darkness or lightness of shading, or any other indication of unique selection. Also in this example, the cursor 1720, which is in the shape of a hand, changes to open hand format. The open hand format of the cursor 1720 and the changed background 1722 together indicate that the first collection card 1710 is now draggable.

In response to the user clicking down on the mouse or other pointer, the cursor 1720 changes from open hand format to closed hand format. This is illustrated in view 1702. Further, the first collection card 1710, the second collection card 1712 and the third collection card 1714 all collapse to the compact view showing just a single row of images in each respective collection 1710, 1712, 1714. The selected first collection changes highlighting to a different appearance, in one example to slightly darker shading of the background 1722. The changes to the background 1722 and the cursor 1720 indicate to the user that dragging of the first collection card 1710 is now enabled.

In view 1704, when dragging of the first collection card 1710 begins, a changed appearance version of the first collection card 1710 appears adjacent to the cursor 1720. In the illustrated example, a minimized ghosted version 1724 of the first collection card 1710 appears and begins moving with the cursor 1720. In the example, as soon as the cursor has dragged the minimized ghosted version 1724 past half of the first collection card 1710, a drop target 1726 is acquired. In general, the drop target 1726 is located between two other collection cards as a potential location to which the first collection card 1710 is to be moved. In the example, the drop target 1726 is shown as a blue line between the second collection card 1712 and third collection card 1714. The drop target 1726 is updated as the cursor 1720 is moved so that the drop target closest to the current position of the cursor 1720 is always highlighted. Collection cards below the drop target 1726 such as the third collection card 1714 move downward to make room for the highlighted drop target 1726.

When the user has positioned the cursor 1720 and the ghosted version 1724, the user releases the mouse and un-clicks the first collection card 1710. In response, the original instance of the first collection card 1710 collapses and disappears from the view and a new instance of the first collection card 1710 at the new location appears. Next, all collection cards including the first collection card 1710, the second collection card 1712 and the third collection card 1714 expand to normal organization mode view, as in view 1702.

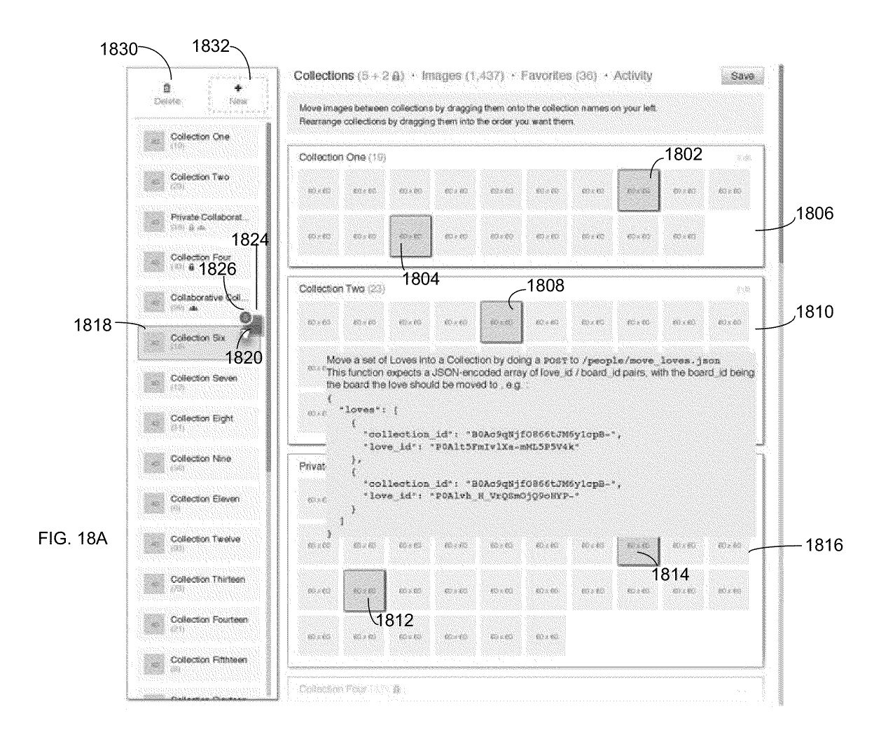

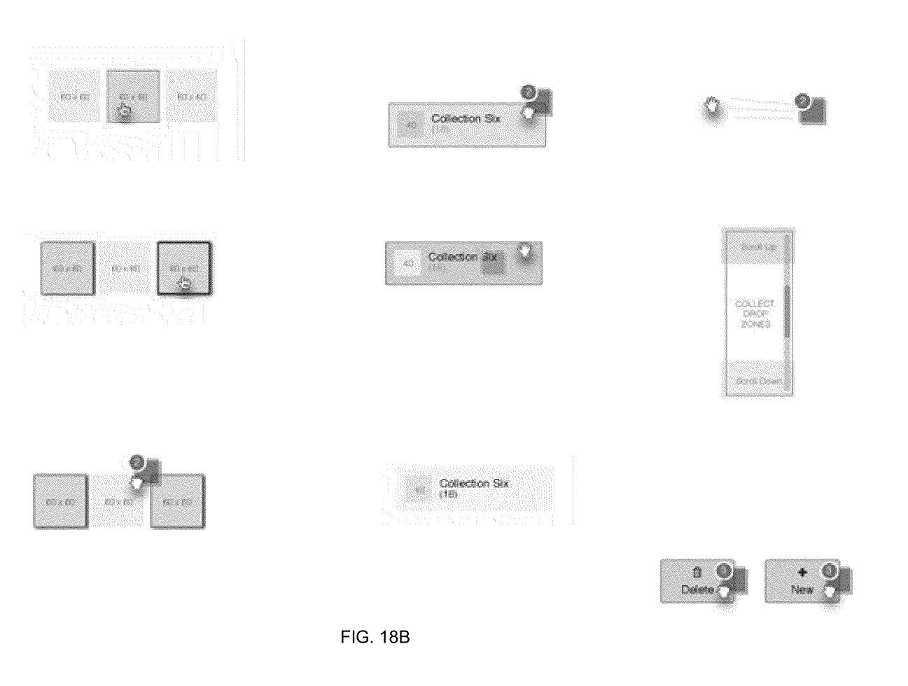

FIG. 18 is an example showing dragging and dropping of images in a web browser that may be displayed to a user and performed by the user of the multimedia content sharing system of FIG. 1. In the exemplary multimedia content sharing system, in general, dragging and dropping an image corresponds to moving the image from one location to a new location. This is true for images that are owned by the user who is dragging the images or for images that have been pinned by the user. An exception occurs when the user is viewing a collaborative collection and drags an image which she has not pinned to the collection. In that example, the image is copied.

FIG. 18 illustrates one example of how images can be moved from one or more source collections to a destination collection. In this example, a first image 1802 and a second image 1804 from a first collection card 1806 titled Collection 1, a third image 1808 from a second collection card 1810 titled Collection Two, and a fourth image 1812 and a fifth image 1814 from a third collection card 1816 titled Private Collection are to be moved to a destination collection 1818 titled Collection Six.

When a cursor such as the cursor 1820 is moved over an image, a thin outline appears around the image and denotes the image as selectable. When the mouse is clicked over the image, a darker, slightly thicker outline appears around the image as well as a drop shadow. These changes indicate that the image is selected. Clicking a selected image a second time de-selects the image. Multiple images may be selected together into a selected image group by any conventional user interface device. For example, on a computer using the Windows operating system, holding the Control key and repeatedly clicking on images adds the respective images to the selected image group.

Once one or more images are selected, a drag may be initiated. On click and drag, on any of the selected images in the selected image group, dragging of the group begins. The selected images stay in their original position and in the selected state. A minimized and ghosted version of a stack of images 1824, together with a number 1826 indicating the number of images in the selected image group being dragged follows the cursor 1820.

When the cursor 1820 enters a valid drop target area such as the area of the destination collection 1816, the target area changes in appearance. In one example, the target area lights up by the addition of an outline and shift in background color. When the mouse is released, the ghosted drag object resolves, the cursor changes from closed hand format to open hand format and the target flashes once. To conclude the process of accepting the drop, the selected image thumbnails on the source collection cards fade away. An exception is for any selected images that the user did not pin herself or does not own. Those images are copied rather than moved. Where the selected images fade away in the displayed collections, the image thumbnails to the right and below the faded thumbnail float left and up. The collection count of the number of images contained in the collection is increased by the number of images added. Further, the drop target area returns to its normal, non-highlighted state.

In some embodiments, the user may release the drag and drop in midair, as it were, before reaching a target area. If the selected group is released without being over a valid target, the cursor changes form closed hand format to open hand format and the ghosted drag object snaps back to the position where the dragging initiated. However, the selected thumbnails remain selected.

If the number of collections in a user's profile exceeds the vertical height of the display, a scrollbar may be added to the collections section near the left side of the display. Dragging objects over the scrolling area initiates scrolling. In some embodiments, the speed of scrolling may be elastic, meaning that the speed of scrolling starts out slow and gradually increases until it gets close to the top or bottom of the list where it gradually starts slowing down again to come to a complete stop when the top or bottom is reached.

The illustrated web page includes a delete button 1830 and a new button 1832. If the user, when dragging and dropping an image or selected group of images, drops an object on the delete button 1830, the operation proceeds like dropping the object on a target area. However, if any of images being dragged were not pinned or owned by the user, the number 1826 on the ghosted drag object is adjusted down to count only the user's own images. Similarly, dragging objects onto the new button 1832 operates similar to dropping objects on a collection target area. The dropped objects are placed into a new collection and the user is given the opportunity to define the new collection.

Image and Collection Recommendation

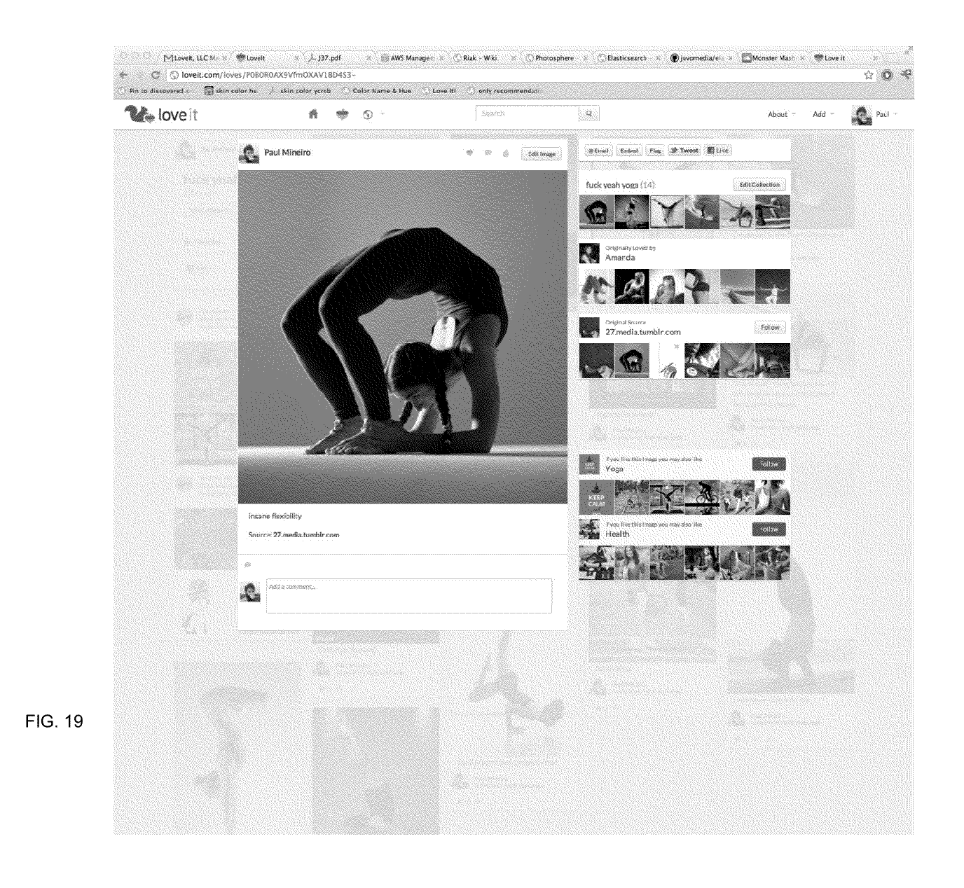

FIG. 19 is an image detail view of an image found anywhere in the multimedia content sharing system. The image may be in the user's collection or any other collection in the system. In the image detail view, the user may view information regarding one image. On the left hand portion of the image detail view, the subject image is displayed. On the upper right hand side of the image detail view, three strips are shown. The top strip includes thumbnail images of the collection to which the subject image belongs. The images are accompanied by the title of the collection, a count of the number of images contained in the collection and an Edit Collection button if the user is the owner of the collection.

The middle strip on the upper right hand side of the image detail view shows thumbnail images from the user who originally pinned the image. The displayed images may come from one collection or many collections. The viewing user may click on any image and see an image detail view of that image.

At the bottom of the upper right hand side of the image detail view of FIG. 19, thumbnails of images from the source of the subject image are displayed. The displayed images are other images from the same source as the subject image. The same source may be the same web site, for example, 27.media.tumblr.com in the illustrated example. The displayed images are other images from the identified source which have also been pinned elsewhere in the multimedia content sharing system.

At the lower right side of the image detail view, recommended collections are displayed. Two recommended collections are displayed in this example. They are displayed as a strip of thumbnail images from the collections arranged on an alternate color background. In the example, the background of the recommended collections is light yellow to contrast with the white or gray background of the rest of the image detail view. The recommended or suggested collections are displayed with the legend, “If you like this you might also like,” a title of the recommended collection and a Follow button. Clicking the Follow button causes the user to begin following the collection.

The subject image is displayed with optional operations. Above the image are user interface operations to pin or love the image; to comment on the image; or to like the image. Further, there is an opportunity to edit the subject image if the user is authorized. The subject image is also displayed with its title and its source such as a uniform resource locator (URL) on the internet.

To the right of the subject image, three collections are displayed in compact view. The first collection displayed is the collection which contains the subject image. In the compact view of this collection, a predetermined number (such as six) of the images of the collection are displayed, along with the title of the collection, the count of images in the collection and an Edit Collection button if the user has authority within the system to edit the collection.

Below the user's collection is displayed a portion of the collection which originally contained the image, along with the legend “Originally Loved by Amanda,” where Amanda is another user.

Finally, the original source of the subject image is displayed. This is generally a network source such as 27.media.tumblr.com in the illustrated example. Other images from the source are displayed in a strip. Moreover, a Follow button is displayed near the strip. Clicking the Follow button will cause the user's account to follow the source of the images. As new images appear in the system from that source, they will appear in the user's home view as well.

Below the displayed collections on the right hand side are two suggested collections. These are displayed with a different background color (such as yellow in place of white) along with the legend “If you like this image you may also like” and the title of the collection. Each of the suggested collections includes a Follow button. Clicking the Follow button causes the user's account to follow the selected collection.

When viewing an image such as the subject image, the multimedia content sharing system may recommend other collections of images to the user. The following is an outline of the process for doing this.

First, analyze the image and containing collection to get candidate search queries. Text associated with the subject image and the collection containing that subject image is collected and processed. For example, the image caption, the collection title and the image page title may be scanned. The text may also include captions provided by others for the image, comments by others about the images, and other text available. All unigrams (single words) and bigrams (consecutive word pairs) are scored. Scoring is based on term frequency-inverse document frequency (TF-IDF) weighting. IDF numbers are taken from a reference corpus. The text is processed to generate one or more search queries. Processing may include recognizing unusual or rare words that suggest a more earnest or heartfelt response to or comment about the image. Candidate search queries are considered in decreasing order of score.

Second, perform candidate search queries to construct candidate set of images. A database of indexed text from other images is searched using the queries generated in the first step. In one embodiment, this search terminates when 40 candidates are found or when no more candidate search queries are available.

Third, the process aggregates candidate images by their containing collection to get a candidate set of collections.

Fourth, each candidate collection is scored using image-collection similarity, such as the process described below.

Fifth, the process returns the best two collections. In the example of FIG. 19, those two collections are shown on the lower right of the view.

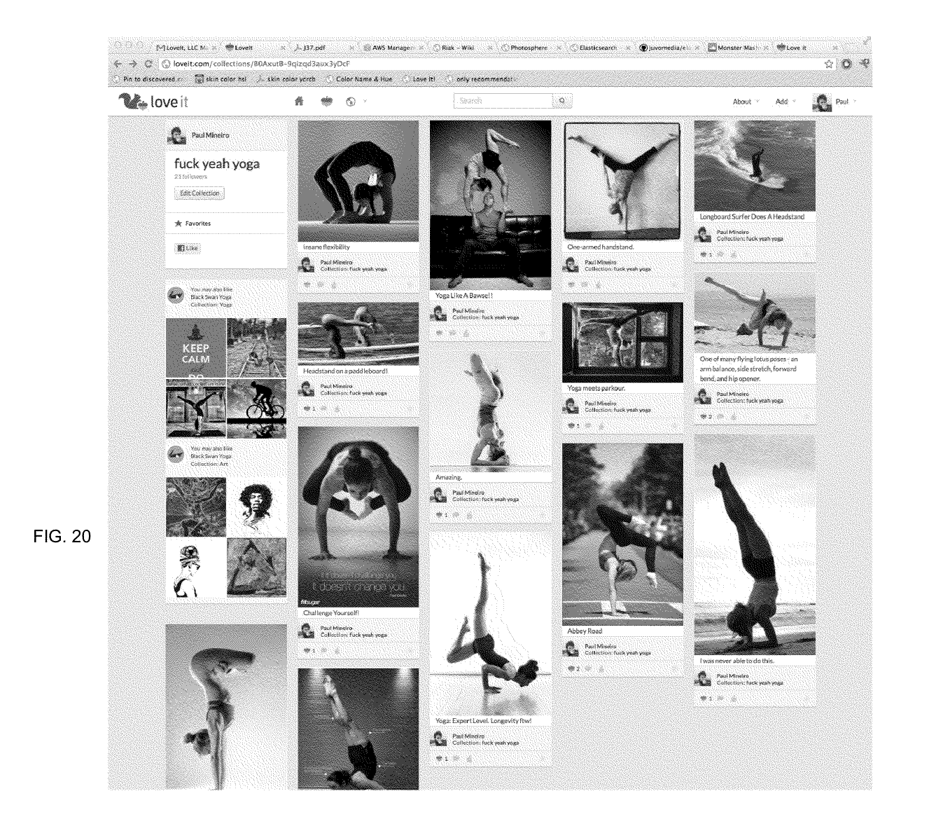

FIG. 20 is a collection detail view of a user's collections. In the collection view, the images are arranged on the browser page like cards on a table top. On the left hand side of the collection detail view an identification card for the owner of the collection is shown. The identification card includes identifying information for the collection, for example, identifying the owner of the collection, the title of the collection and a count of its contained images. An Edit Collection button is provided to allow the owner to edit her collection. Each image in the collection is provided with information such as its title, the user name and any comments by the user. This is the view of his collection presented to the user.

Below the identification card, on the left hand side of the collection detail view, are two suggested collections. These are displayed with a different background color (such as yellow in place of white) along with the legend “You may also like” and the title of the suggested collection and four image thumbnails from the suggested collection.

When viewing a collection such as the collection displayed in FIG. 20, the multimedia content sharing system may recommend other collections of images to the user. The following is an outline of the process for doing this.

First, analyze the target collection to get candidate search queries. This may be done by collecting all text associated with all images in the collection. This includes titles, comments captions, etc. This also includes scoring all unigrams and bigrams. Scoring is based on TF-IDF, where IDF numbers are taken from a reference corpus. The text is used to form query terms to locate relevant collections. Candidate search queries are considered in decreasing order of score.

Second, perform candidate search queries using the query terms to construct a candidate set of images. This process may terminate, for example, when 40 candidates are found or when no more candidate search queries are available.

Third, aggregate candidate images by their containing collection to get candidate set of collections.

Fourth, score each candidate collection using collection-collection similarity, as will be described below.

Fifth, return best two collections. These are displayed for viewing on the collection view page as in FIG. 20.

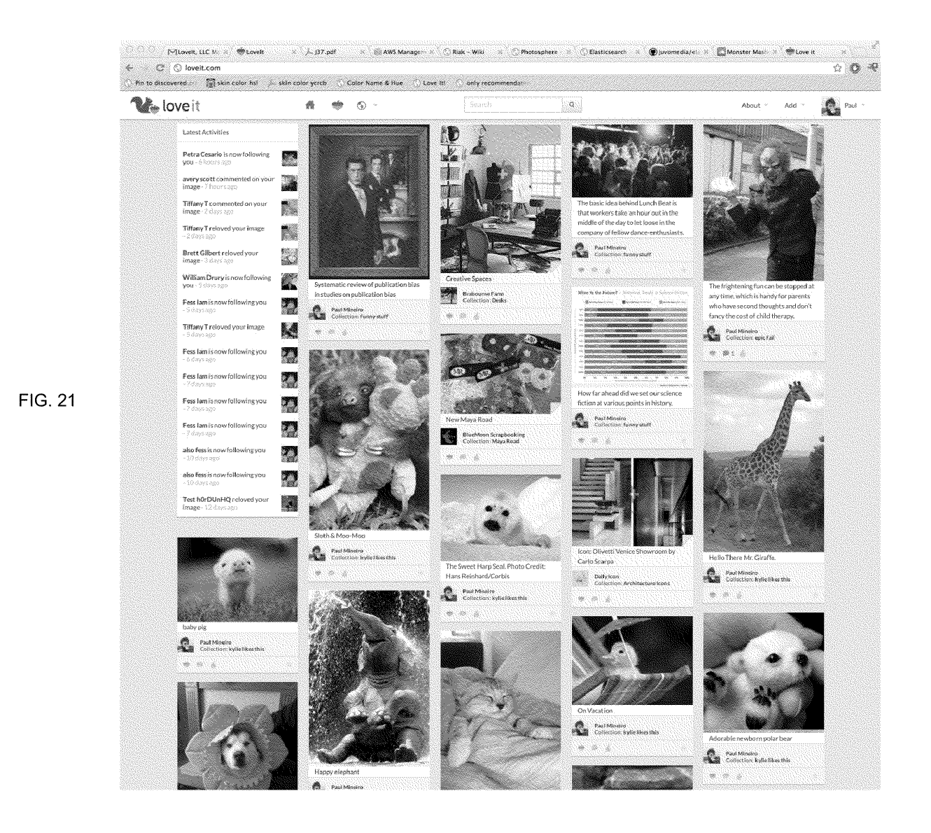

FIG. 21 is a front stream view of a user's collections. The front stream view displays all the user's images in his collections in timewise order. More recently selected images are shown near the top of the page. Recent activity regarding the user's account, such as other users following the user or the user choosing to follow other users, are displayed on the left hand side of the page.

Interspersed among the displayed images on the front stream view are several suggested images. These are displayed with a different background color (such as yellow in place of white) along with the source and collection name of a containing collection. Each of the suggested collections includes a Follow button. Clicking the Follow button causes the user's account to follow the selected collection.

When viewing a collection such as the collection displayed in FIG. 21, the multimedia content sharing system may recommend other collections of images to the user. The following is an outline of the process for doing this.

First, for each collection followed by the user, analyze the collection to get candidate search queries and perform candidate search queries to construct candidate set of images. The analysis and searching may be similar to those described above in conjunction with FIGS. 19 and 20. For example, all captions and page titles are scanned for each image in the target collection, along with the collection title. The search may terminate when 40 candidates are found or when no more candidate search queries are available. Also, the process scores each candidate image using collection-image similarity as described below. Bigrams and unigrams are scored. Then all recommended images are returned in decreasing order of score. Scoring of a word or a phrase is based on TF-IDF. IDF numbers are taken from the reference corpus. Candidate search queries are considered in decreasing order of score.

Second, the process merges the recommendation lists generated in the above first step, breadth-first. That is, the process takes the first recommendation from each collection, and once all collections have had one recommendation consumed, takes the second recommendation from each collection.

Third, the process interleaves recommendations randomly into the front stream with a particular target density. In one example, target density is 1 in 10 images.

Similarity Functions

A first similarity function is collection-image-image similarity. All similarity functions are built from a primitive which is:

collection-image-image (Collection, PositiveImage, ProbeImage)->Score

This primitive captures the propensity for the ProbeImage to be found in a Collection with a PositiveImage which is in that Collection. This scoring function is what the training procedure outlined above constructs.

A second image-collection similarity is used on image detail page, FIG. 19. It is an average of the collection-image-image similarity scores for each image in the collection, with respect to the collection that contains the image.

image-collection similarity (Collection, Image):
for each PositiveImage in the Collection

score+=collection-image-image (CollectionAssociatedWith (Image), Image, PositiveImage)

score/=number_of_images_in (Collection)

Third is collection-collection similarity. This is used on the collection detail page, FIG. 20. It is an average of the image-collection similarity scores for each image in the (first) collection.

collection-collection similarity (CollectionOne, CollectionTwo):

for each Image in CollectionTwo

score+=image-collection similarity (CollectionOne, Image)

score/=number_of_images_in (CollectionTwo)

This function is not symmetric, but that is acceptable for this purpose. CollectionOne is being looked at, and CollectionTwo is a candidate recommendation, so they are different.

Fourth is collection-image similarity, which is not to be confused with image-collection similarity. It is an average of the collection-image-image similarity scores for each image in the collection.

collection-image similarity (Collection, Image):

for each PositiveImage in Collection

score+=collection-image-image (Collection, PositiveImage, Image)

score/=number_of_images_in (Collection)

Following a Source or Other Medium

A source may be defined as the particular domain where a pinned item originated. In some examples, the source of the pin or image or other multimedia item may be displayed in association with that item. An example is a network source such as 27.media.tumblr.com in the example shown in FIG. 19. A source may have a URL structure, as in this example, or may give any indication of a domain where the item originated. Other examples are yahoo.com or sports.yahoo.com.

In accordance with some embodiments, the method and system herein may permit a user to follow a source of an item on the network. One example is a Really Simple Syndication (RSS) feed. Some blogs and other internet locations originate material which may be of interest to users of the multimedia sharing system. In one embodiment, a user may select an RSS feed, such as a photo blog, to follow among his collections.

Going further, an RSS feed may include other extraneous information as well that is not of interest or is of lesser interest to a user of the multimedia sharing system. For example, in addition to interesting photos, images and other multimedia items, the RSS feed may include advertising or commentary which is not easily filtered. Other information may not be image-centric.

By making a source available to follow by a user, the user is able to benefit from additional selection, editing and curation provided by others associated with the source. The fact that the image was placed on the source indicates that someone thought the image merited posting and sharing. For examples, commercial enterprises with presences online are producing good sources for images. These include, for example, publishers such as Vogue magazine, National Geographic magazine and Sports Illustrated magazine, in their online editions.

A source then is any image that is available on the multimedia sharing system from a particular host or domain. The source may be defined by a URL, such as where a browser is redirected upon clicking on an image, or the URL defining the web page where the image originated. In the exemplary embodiment, a user may follow a source by clicking on a Follow button near the source or even clicking on a link about the source itself. Following a source or other entity operates much like following another user or a collection. When the following user refreshes his view, he is given a notice that the collection has updated and new images from source will appear in the user's photo stream.

In addition to selecting a source to follow, a user may also follow other entities in the multimedia sharing system. Examples are a search query and a brand. For example, a photographic supplier may have a website with a wide variety of images of high quality appealing to a variety of interests. That supplier may further sell goods or services under one or more brands. By selecting a brand name to follow, the user of the multimedia sharing system can automatically receive regular updates of images associated with that brand. Moreover, the supplier may recognize that such users of the multimedia sharing system represent potential customers or clients and may in turn target them, using the multimedia sharing system as a communications channel. Such an arrangement may be profitable for users who find multimedia items that appeal to their particular interest, to suppliers of goods and services that find enthusiastic purchasers, and to the operator of the multimedia sharing system that benefits from bringing the other parties together.

Tying the connection to a brand name gives builds on a relationship that already exists between the supplier and customers. Customers use brand names for indications of source, quality and reliability. Certain brands are trusted by customers. A brand can be especially useful for a customer who is a new user to a multimedia sharing system. Following the brand helps bring to him information about trusted goods or services based on the trust built by the brand.

Similarly for the supplier of those goods and services, he has spent time and resources building a brand that his customers can rely on. By making his brand available to the operator of the multimedia sharing system, the brand owner may make new use of the brand to attract and inform customers.

For the operator of the multimedia sharing system, the ability to provide brands that may be followed allows the operator to build up users of the multimedia sharing system. The benefits of increasing user comfort and familiarity accrue to the operator of the multimedia sharing system as well. Making brands available to be followed is a way to monetize the multimedia sharing system.

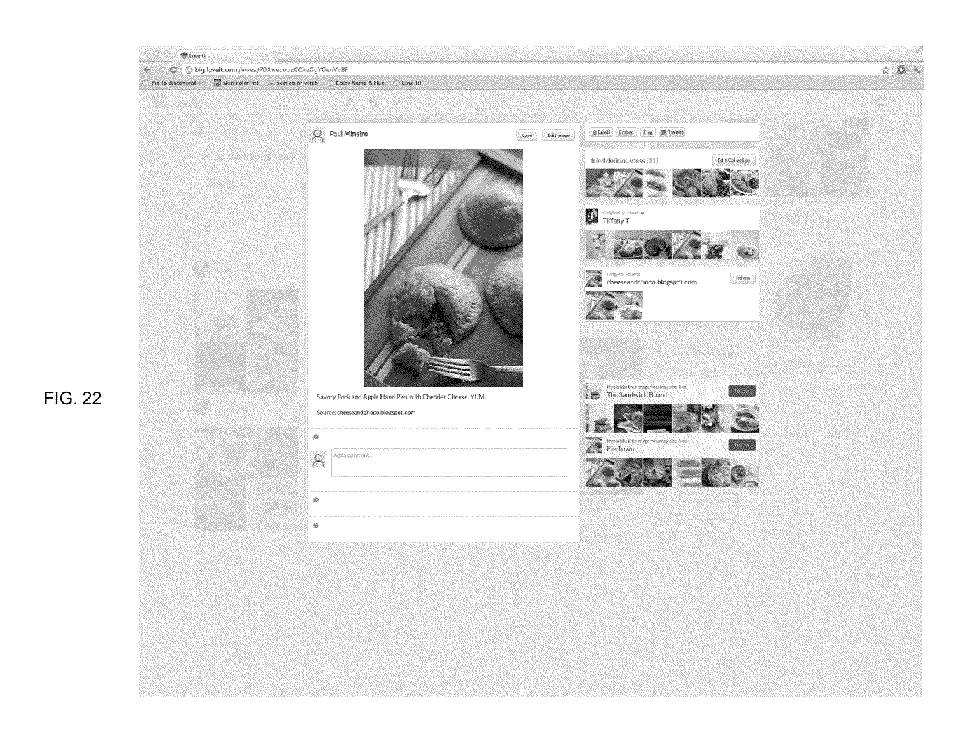

FIG. 22 is an image detail view of a user. The image detail view shows an image on the left hand side of the view and, on the right hand side, additional information. On the lower right, two suggested collections are provided to the user by the multimedia content sharing system. The suggested collections includes a strip of thumbnail images, a title, the legend, “if you like this image, you may also like” and a Follow button inviting the user to follow the suggested collection. On the upper right, a portion of the containing collection which contains the image is shown, along with a button inviting the user to Edit Collection. Below that is a portion of the originating collection, including a strip of thumbnail images and the name of the sharing user, Tiffany T, that originally pinned or loved or shared the image. In this embodiment, the name of the sharing user is a link and clicking the link causes the viewing user to begin following the sharing user, Tiffany T. Below the originating collection is a portion of the image source which contains the image. The image source includes a row of thumbnail images, text identifying the source, in this example, cheeseandchoco.blogspot.com, and a Follow button. Clicking the Follow button will cause the viewing user to begin following the source.

The methods, devices, and logic described above may be implemented in many different ways in many different combinations of hardware, software or both hardware and software. For example, all or parts of the system may include circuitry in a controller, a microprocessor, or an application specific integrated circuit (ASIC), or may be implemented with discrete logic or components, or a combination of other types of analog or digital circuitry, combined on a single integrated circuit or distributed among multiple integrated circuits. All or part of the logic described above may be implemented as instructions for execution by a processor, controller, or other processing device and may be stored in a tangible or non-transitory machine-readable or computer-readable medium such as flash memory, random access memory (RAM) or read only memory (ROM), erasable programmable read only memory (EPROM) or other machine-readable medium such as a compact disc read only memory (CDROM), or magnetic or optical disk. Thus, a product, such as a computer program product, may include a storage medium and computer readable instructions stored on the medium, which when executed in an endpoint, computer system, or other device, cause the device to perform operations according to any of the description above.

The processing capability of the system may be distributed among multiple system components, such as among multiple processors and memories, optionally including multiple distributed processing systems. Parameters, databases, and other data structures may be separately stored and managed, may be incorporated into a single memory or database, may be logically and physically organized in many different ways, and may implemented in many ways, including data structures such as linked lists, hash tables, or implicit storage mechanisms. Programs may be parts (e.g., subroutines) of a single program, separate programs, distributed across several memories and processors, or implemented in many different ways, such as in a library, such as a shared library (e.g., a dynamic link library (DLL)). The DLL, for example, may store code that performs any of the system processing described above. While various embodiments of the invention have been described, it will be apparent to those of ordinary skill in the art that many more embodiments and implementations are possible within the scope of the invention. Accordingly, the invention is not to be restricted except in light of the attached claims and their equivalents.

1. A method for a multimedia content sharing system, the method comprising:
at a server system,
providing multimedia items to a user operating a user device in data communication over a network with the server system;
detecting user interaction with the provided multimedia items;
based on the user interaction; selecting additional multimedia items to suggest to the user;
communicating the additional multimedia items to the user;
detecting a monetary amount to be paid by an information provider in return for suggestion of particular additional items or promoted content; and
based in part on the detected monetary amount, selecting additional items for the user; and
communicating the additional items to the user.

2. The method of claim 1 further comprising:
at the server system,
storing in a memory information defining a respective information provider, a respective specified action to be taken by a user viewing multimedia items in the server system and a respective bid amount payable by the respective information provider upon taking of the specified action by a user.

3. The method of claim 2 wherein storing information comprises storing information defining an impression of information associated with the respective information provider viewed by a user.

4. The method of claim 3 further comprising:
storing as a subscribing user's collection a plurality of multimedia items selected for collection by a user;
displaying a multimedia item of the subscribing user's collection to the user;
providing a selectable link for the user to select to begin following the subscribing user's collection; and
in response to actuation of the selectable link, initiating a following relationship between the user and the source.

5. The method of claim 4 wherein storing information comprises:
storing information defining the subscribing user's collection in association with the respective information provider and a bid amount payable upon actuation of the selectable link by the user.

6. The method of claim 1 further comprising:
optimizing placement of the particular items of promoted content to maximize revenue paid by the information provider.

7. The method of claim 1 further comprising:
optimizing placement of the particular items of promoted content to maximize relevance of the promoted content to the user.

8. The method of claim 1 further comprising:
optimizing placement of the particular items of promoted content to maximize likelihood of future interaction with the server system by the user.

9. A computer implemented method comprising:
at a server computer, providing a user interface to a remote user, the user interface providing interaction with features of a local website;
through the user interface, receiving a multimedia selection by the remote user, the multimedia selection to be added to an online collection defined by the user and accessible by the user via the user interface;
analyzing information received from the user interface about the multimedia selection; and
based on the analyzed information, proffering to the user additional multimedia items for the user to optionally select to add to the online collection.

10. The computer implemented method of claim 9 wherein analyzing information received from the user interface comprises analyzing descriptive text provided by the user for the online collection.

11. The computer implemented method of claim 9 further comprising:
analyzing features of one or more multimedia items included by the user in the online collection; and
based on the analyzed features, proffering to the user additional multimedia items.

12. The computer implemented method of claim 9 further comprising:
based on the analyzed information, constructing a search query;
searching records of the local web site to identify multimedia items relevant to the search query to obtain search results; and
proffering one or more additional multimedia items to the user based on the search results.

13. The computer implemented method of claim 9 further comprising:
based on the analyzed information, proffering to the user additional multimedia items based on promoted content sponsored by one or more promoters.

14. The computer implemented method of claim 13 further comprising:
receiving information from the one or more promoters defining respective multimedia items, a respective action for the respective multimedia items and a respective bid amount payable by a respective promoter upon occurrence of the respective action.

15. A method for a multimedia content sharing system, the method comprising:
at a server system,
storing multimedia items as a plurality of collections associated with users;
displaying a multimedia item of a user's collection to the user who accesses the server system over a network;
displaying to the user brand information about a supplier of goods or services pertinent to the multimedia item, the supplier being associated with a brand identified by the brand information;
providing a selectable link for the user to select to begin following the brand; and
in response to actuation of the selectable link, initiating a following relationship between the user and the brand.

16. The method of claim 15 further comprising:
establishing an account of an owner of the brand with an operator of the multimedia content sharing system; and
upon selection of the link or initiation of the following relationship between the user and the brand, debiting the account by the owner of the multimedia content sharing system.

17. The method of claim 16 further comprising:
storing in the account information identifying a bid amount and a display preference of the owner of the brand; and
displaying the multimedia based on the display preference of the owner of the brand.

18. The method of claim 17 wherein displaying the multimedia based on the display preference of the owner of the brand comprises:
adjusting the prominence of the displayed brand information relative to other multimedia items displayed to the user using the bid amount.
